(19) United States
(12) Patent Application Publication
(10) Pub. No.: US 2015/0039344 A1
(43) Pub. Date: Feb. 5, 2015

(54) AUTOMATIC GENERATION OF EVALUATION AND MANAGEMENT MEDICAL CODES

(71) Applicant: ATIGEO LLC, Bellevue, WA (US)

(72) Inventors: Rodney Kinney, Bellevue, WA (US); Michael Sandoval, Bellevue, WA (US); Jonathan Cross, Bellevue, WA (US); Bryan Tinsley, Bellevue, WA (US); Manjula Iyer, Bellevue, WA (US); David Talby, Bellevue, WA (US)

(73) Assignee: ATIGEO LLC, Bellevue, WA (US)

(21) Appl. No.: 14/451,019

(22) Filed: Aug. 4, 2014

Related U.S. Application Data
(60) Provisional application No. 61/861,811, filed on Aug. 2, 2013.

(51) Int. Cl. G06F 19/00

(52) U.S. Cl. CPC G06F 19/322
USPC 705/3

(57) ABSTRACT

The current document is directed to methods and systems for automated generation of evaluation and management medical codes (“E/M codes”). In one implementation, a series of processes are applied to a medical document in order to generate annotations and concepts, extract metadata, and, using the annotations and concepts, and, in certain cases, the extracted metadata, to generate a set of feature/feature-value pairs that parametrically represent the contents of the medical document. Models for E/M codes and E/M-code components are generated to contain sets of weights, each weight corresponding to a feature for which a feature-value is automatically generated from medical documents. These weights are used as multipliers, in certain implementations, of the feature values generated for a medical document. Multiplication of feature values by corresponding weights produces terms that are used to generate scores for each of various different E/M codes. The generated scores provide a basis for selecting one or more E/M codes for the medical document.

### CROSS-REFERENCE TO RELATED APPLICATION

This application claims the benefit of Provisional Application No. 61/861,811, filed Aug. 2, 2013.

### TECHNICAL FIELD

The current document is directed to automated medical-claims processing systems, medical billing systems, and other automated medical-information-processing systems and, in particular, to an automated system for generating evaluation and management medical codes for medical documents.

### BACKGROUND

A significant portion of payments made to medical-services providers by patients are forwarded to medical-services providers by insurance companies on behalf of the patients. Physicians and clinics generally submit, to the insurance company through which the patient is insured, medical documents that describe a patient visit, including descriptions of the patient's medical history, the examination of the patient during the patient visit, the attending physician's diagnosis, tests and procedures ordered by the physician, other treatment details, and drugs prescribed to the patient. The medical documents are generally accompanied by one or more evaluation and management medical codes (“E/M codes”) that numerically summarize the patient visit. The insurance company uses the submitted information to determine an appropriate reimbursement for the physician or clinic.

E/M codes can be determined manually by a physician or clinic personnel from a medical document by working through a set of complex E/M-code-generation rules. In certain cases, generation of E/M codes has been at least partially automated by attempting to automate the complex rule-based E/M-code-determination process. However, in many cases, partial or full automation based on the complex E/M-generation rules is error prone and computationally difficult. In addition, there are many problems associated with E/M codes, including fraudulent billing by systematically generating codes associated with higher reimbursement than the codes that would be associated with medical documents based on the complex rules, systematic errors in partially or fully automated E/M-code-generation systems, and computationally intensive problems associated with processing enormous numbers of insurance claims by large medical-services organizations, insurance companies, and various third-party organizations involved in processing insurance claims, generating reimbursement instruments for medical-services providers, and arranging for the reimbursements to be transmitted to the medical-services providers. As a result, designers and developers of medical billing systems, insurance companies, medical-services organizations, and many other individual and organizations continue to seek accurate, reliable, and computationally efficient methods and systems for determining E/M codes for medical documents.

### SUMMARY

The current document is directed to methods and systems for automated generation of evaluation and management medical codes (“E/M codes”). In one implementation, a series of processes are applied to a medical document in order to generate annotations and concepts, extract metadata, and, using the annotations and concepts, and, in certain cases, the extracted metadata, to generate a set of feature/feature-value pairs that parametrically represent the contents of the medical document. Models for E/M codes and E/M-code components are generated to contain sets of weights, each weight corresponding to a feature for which a feature-value is automatically generated from medical documents. These weights are used as multipliers, in certain implementations, of the feature values generated for a medical document. Multiplication of feature values by corresponding weights produces terms that are used to generate scores for each of various different E/M codes. The generated scores provide a basis for selecting one or more E/M codes for the medical document.

### BRIEF DESCRIPTION OF THE DRAWINGS

FIG. 1 provides a general architectural diagram for various types of computers and other processor-controlled devices, including E/M-code-generation-service computer systems, medical-services-provider computer systems, and insurance-company computer systems.

FIG. 2A illustrates a process carried out by the automated E/M-code generation systems and methods to which the current document is directed.

FIGS. 2B-C illustrate determination of a level of care that contributes to generation of an E/M code.

FIGS. 2D-E show various literal section-header texts that may be associated with section categories and the counts of various different concept types that may be associated with particular section categories.

FIGS. 3A-D illustrate various ways in which the currently described automated methods and systems that generate E/M codes can be used in real-world environments.

FIGS. 4A-B illustrate the unstructured-information-management (“UIM”) approach used to implement an E/M-code-generation system as one example of E/M-code-generation-system implementations.

FIG. 5 illustrates an example annotation object that may be instantiated by an annotator within an analysis engine.

FIG. 6 illustrates certain of the low-level annotation objects instantiated by the analysis engine to which one implementation of an E/M-code-generation subsystem interfaces.

FIG. 7 illustrates the logical output of an analysis engine that is represented by an output CAS data object (424 in FIG. 4B).

FIG. 8 illustrates an implementation of a metadata object (704 in FIG. 7) associated with a processed document by an analysis engine.

FIGS. 9A-B illustrate one implementation of a concept object. In this implementation, a concept object is an instantiation of an assertion class.

FIG. 10 illustrates a features object that includes a set of features extracted from a document, generally by one or more annotators within an analysis engine or, in alternative implementations, by functionality within an E/M-code-generation application that processes a CAS data structure returned by an analysis engine.

FIGS. 11A-H provide pseudocode illustrations of the logic included in various annotators instantiated within an analysis engine to which certain implementations of an E/M-code-generation subsystem interfaces.

FIG. 12 provides a control-flow diagram for a routine “text features” that extracts a set of feature/feature-value pairs from a medical document.

FIG. 13 provides a control-flow diagram for the routine “annotation,” called in step 1204 of FIG. 12.

FIG. 14 provides a control-flow diagram for a routine “features.”

FIG. 15 illustrates the model weights used, in certain implementations of the E/M-code-generation methods and systems, to generate scores for E/M codes, including the patient-type/service portions of the E/M codes and the level of care components of the E/M codes.

FIG. 16 illustrates a data structure K returned by a routine, discussed below, that determines the level values for each of the key components for a medical document.

FIGS. 17-18 illustrate the determination of a level-of-care code component for a particular input medical document based on the code-determination pseudocode discussed above with reference to FIG. 11G.

FIG. 19 illustrates computation of a patient-type/service code for a medical document by a routine “patient-type/service code” using the general approach discussed above with reference to FIG. 11G.

FIG. 20 provides a control-flow diagram for a routine “code generation” which determines an E/M code for an input medical document.

FIG. 21 provides a control-flow diagram for a routine “audit” that is executed, in an insurance-company computer system, as discussed above with reference to FIG. 3C, in order to determine whether or not a submitted level-of-care code component is correct, inadvertently miscoded, or constitutes potential billing fraud.

FIGS. 22-26 illustrate one implementation of a model-building method that is used, as discussed above with reference to FIG. 3D, for model building by an E/M-code-generation service.

FIG. 27 illustrates various possible ways of computing an indication to characterize the probability that an incorrect level of care has been inadvertently submitted in a billing request.

### DETAILED DESCRIPTION

The current document is directed to automated systems and methods that generate an E/M code for a medical document, such as a medical document that describes a patient visit to a medical-services provider. The E/M code is generated based on annotations added to the medical document, concepts and features extracted from the medical document, and, in certain cases, on metadata extracted from the medical document. In certain cases, certain structured data that resides in a medical-services-provider's billing system or an E/M-code-generation-service computer system may additionally contribute to generation of an E/M code for a particular medical document. The medical document, as discussed above, may include information about the patient, the type of service provided by the medical-services provider, the medical diagnosis, and other types of information related to the patient visit. The E/M code additionally summarizes the level of care provided during the patient visit. Levels of care are discussed, in greater detail, below. In many of the examples discussed in the current document, a single E/M code is generated and associated with each medical document. In other cases and implementations, multiple E/M codes may be generated from, and associated with, each of numerous medical documents. Generation of multiple E/M codes for a particular medical document is a straightforward extension of the implementation details, provided below, for generation of a single E/M code for a particular medical document.

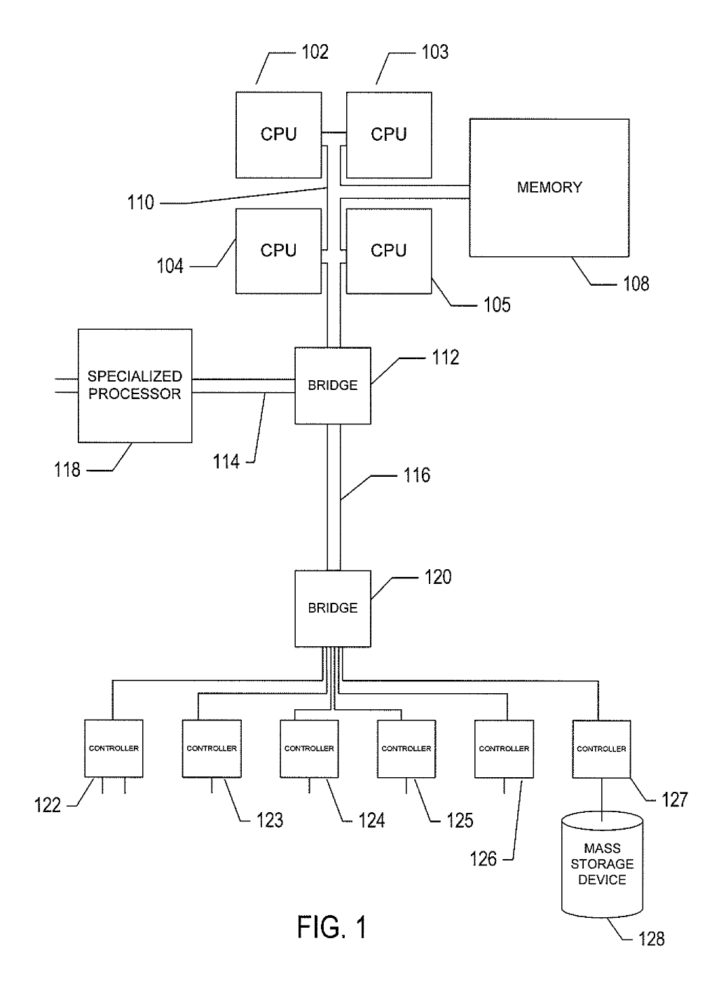

FIG. 1 provides a general architectural diagram for various types of computers and other processor-controlled devices, including E/M-code-generation-service computer systems, medical-services-provider computer systems, and insurance-company computer systems. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources.

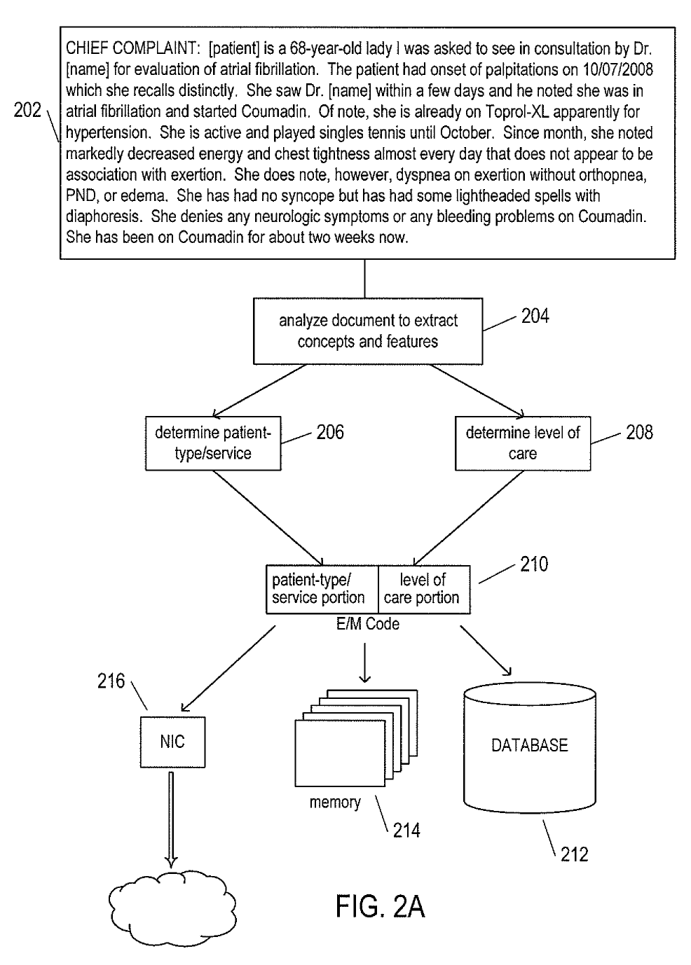

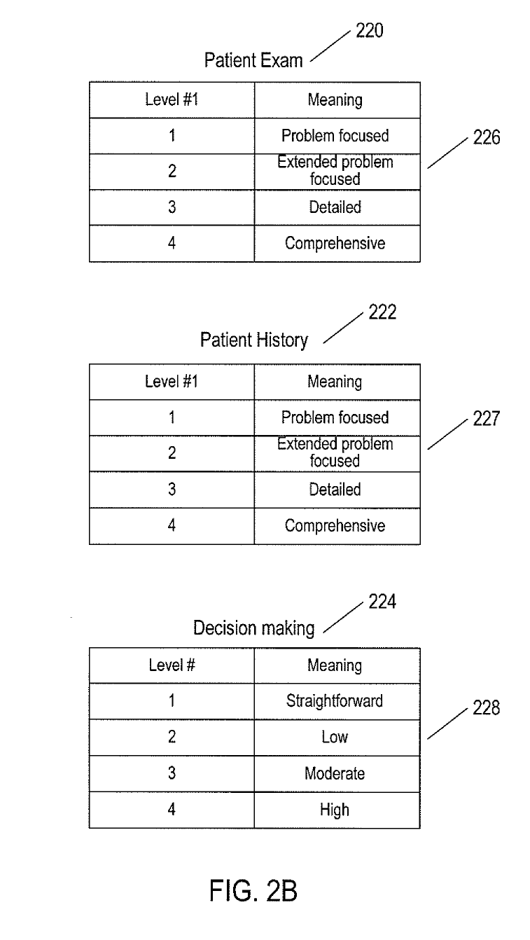

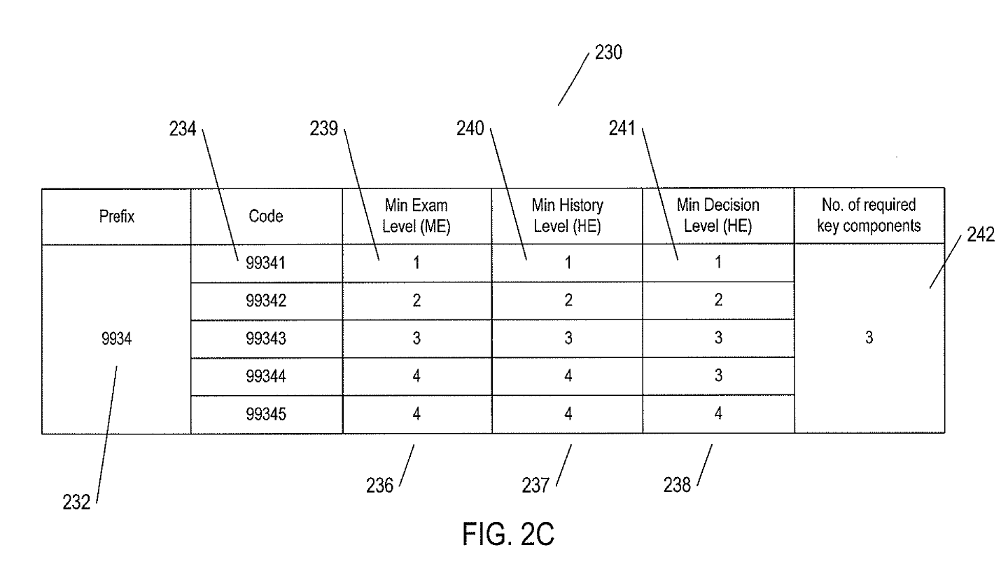

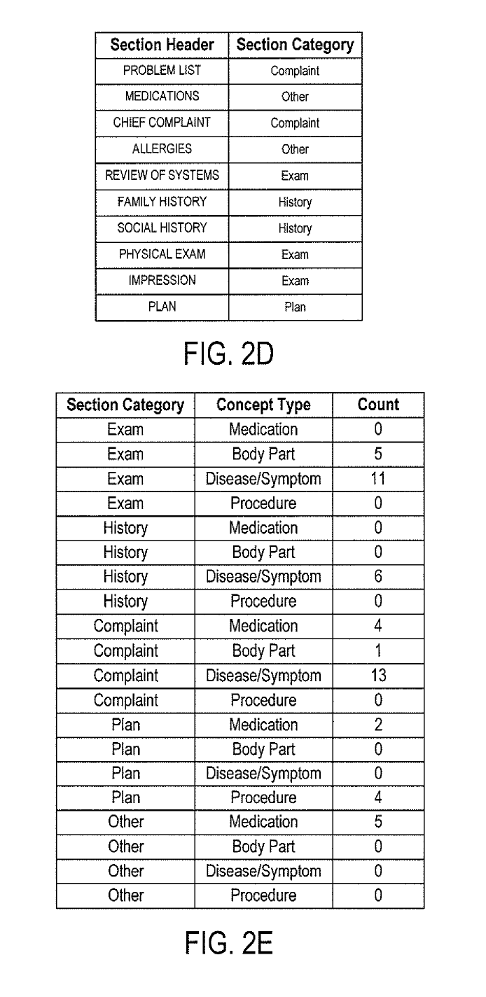

FIG. 2A illustrates a process carried out by the automated E/M-code generation systems and methods to which the current document is directed. At the top of FIG. 2A, a very short example of a medical document 202 is shown. The medical document is an electronic text document that is stored in at least one memory of a computer system and that is often additionally stored in one or more mass-storage devices within one or more computer systems. A medical document may be generated manually, by keyboard entry, may be generated automatically by machine transcription of a recorded patient-visit description, or may be generated semi-automatically by interactions of a user with a medical-services-provider's medical-information system.

A medical document may have multiple different sections within each of multiple different chapters or regions. In the example 202 shown in FIG. 2A, the medical document contains a single section entitled “CHIEF COMPLAINT.” Numerous different organizational and formatting conventions may be used to generate medical documents for input to the currently disclosed E/M-code-generation methods and systems, each of which employs different formatting for section headers. In a first step, the medical document is computationally analyzed to extract concepts and features 204. Concepts and features are discussed, in greater detail, below. Based on the extracted features, the currently disclosed methods and systems determine a patient-type/service code 206 and a level-of-care E/M-code component 208. The patient-type/service code 206 and the determined level of care are combined together to form an E/M code 210 that represents the content of the input medical document 202. The E/M code is then stored in one or more of a database and/or mass-storage device 212 and electronic memory 214 or transmitted through a communications system 216 to one or more memories and/or mass-storage devices of one or more remote computer systems.

It should be emphasized that the currently described methods and systems are in no way abstract and do not comprise disembodied software. Instead, the currently described methods operate on tangible, physical, electronically encoded medical records to produce tangible, physical E/M codes stored in electronic devices. The currently disclosed systems are clearly and unmistakably physical systems that include processors, memory, power supplies, and many other physical components. While the control subsystems of the currently disclosed systems may be, in part, implemented as stored computer instructions that, when executed by one or more processors in one or more computer systems, control the one or more computer systems to carry out E/M-code generation as discussed, in detail, below, they are not software. Software is a sequence of symbols that represent computer instructions and can do nothing. The currently disclosed methods and systems involve complex, computational processes that do not attempt to automate the rule-based code-generation methods previously carried out manually or semi-automatically according to published rules and guidelines for coding. Instead, the currently disclosed methods and systems employ computational models developed through training to efficiently generate E/M codes.

FIGS. 2B-C illustrate determination of a level of care that contributes to generation of an E/M code. As shown in FIG. 2B, there are three key components considered in a level-of-care analysis: (1) the patient exam 220; (2) the patient history 222; and (3) a medical-decision-making key component 224. A complex set of rules are used to assign a particular level to each key component during the level-of-care analysis. In tables 226-228, shown in FIG. 2B, corresponding to key components 220, 222, and 224, respectively, a general description or meaning is shown for each level that can be assigned to the key component. In general, the higher the numeric level, the more comprehensive and time-consuming the tasks performed during a patient visit related to the key component.

FIG. 2C illustrates information used to calculate a level of care for a particular medical document that, when combined with a patient-type/service code generated for the medical document, produces an E/M code. Table 230 provided in FIG. 2C includes information used to calculate a level of care for the particular patient-type/service code “9934” (232 in FIG. 2C). The level of care is a single-digit value that is added to the patient-type/service code as a final digit to produce an E/M code. Thus, a level-of-care value of “1” for patient-type/service code “9934” produces the E/M code “99341” (234 in FIG. 2C). The three columns 236-238 include indications of the minimum level assigned to each of the three key components, discussed above with reference to FIG. 2B, necessary to generate a particular level-of-care value and corresponding E/M code. For example, when the level assigned to each of the key components is “1,” shown in the first entries 239-241 of the three columns 236-238, then an overall level-of-care code “1” is justified, producing the E/M code “99341” (234 in FIG. 2C). A final value in a final cell 242 of table 230 indicates the number of key-component values that need to meet the minimum required levels in order to generate a particular level-of-care code component for patient-type/service code “9934.” In the example shown in FIG. 2C, all three key components must have the minimum required levels shown in a row of the table in order to justify assignment of the corresponding level-of-care code component shown as the last digit in the E/M code provided in the row. Thus, for example, only when all three key components have been assigned the highest level of “4” can the level-of-care code component be assigned the highest possible value “5.” In general, the highest justified level-of-care code-component value, based on the levels assigned to the key components, is used to generate a full E/M code for a medical document.

In various implementations of the currently disclosed E/M-code-generation methods and systems, additional types of tabulated information may be employed. For example, as shown in FIG. 2D, various literal section-header texts may be associated with section categories and, as shown in FIG. 2E, the counts of various different concept types that may be associated with particular section categories may be tabulated. These counts may be used as feature values in subsequent code-generation processes.

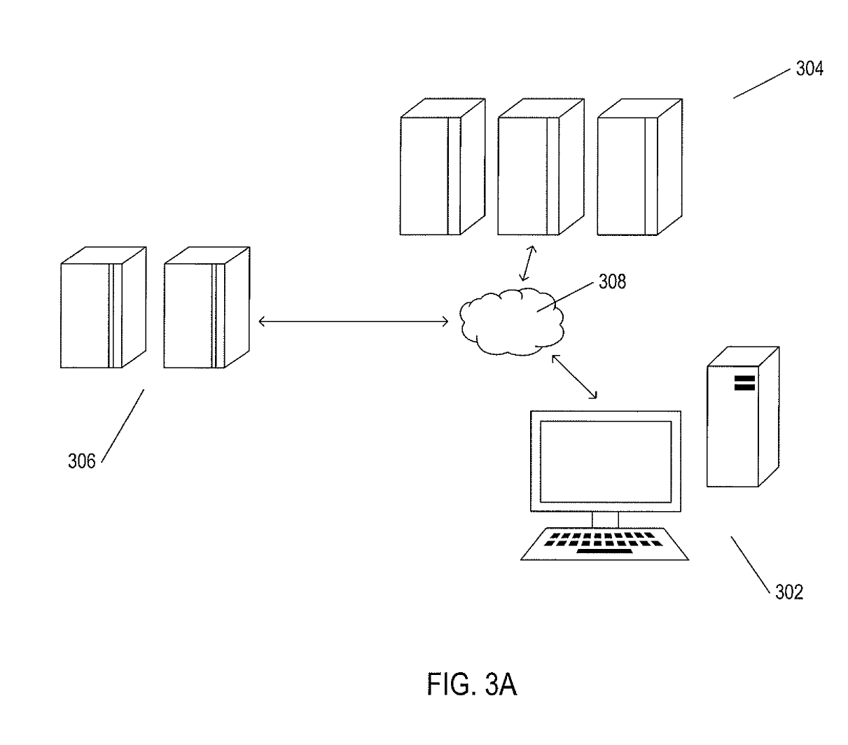

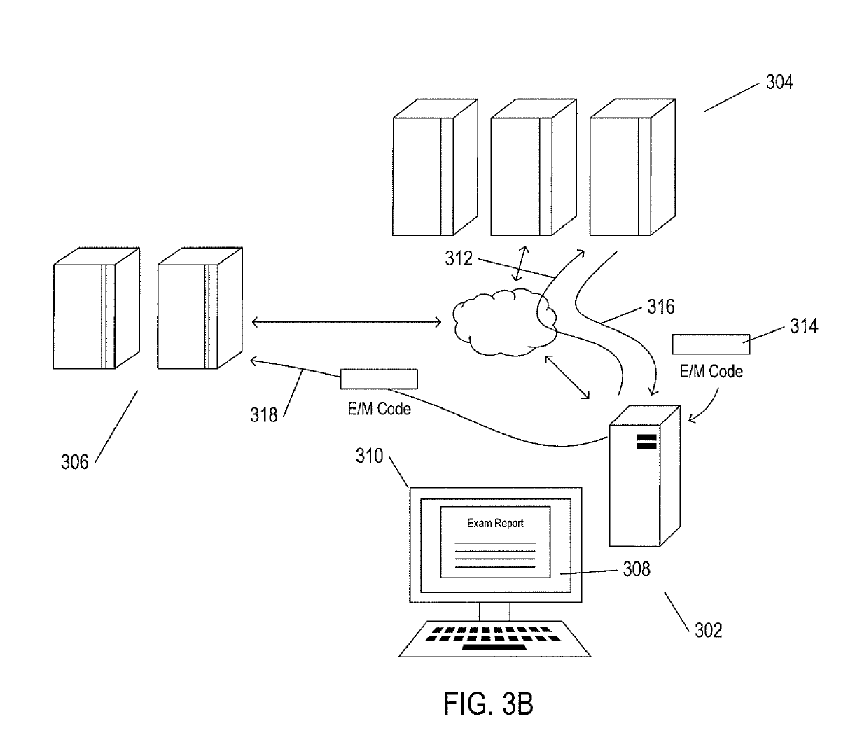

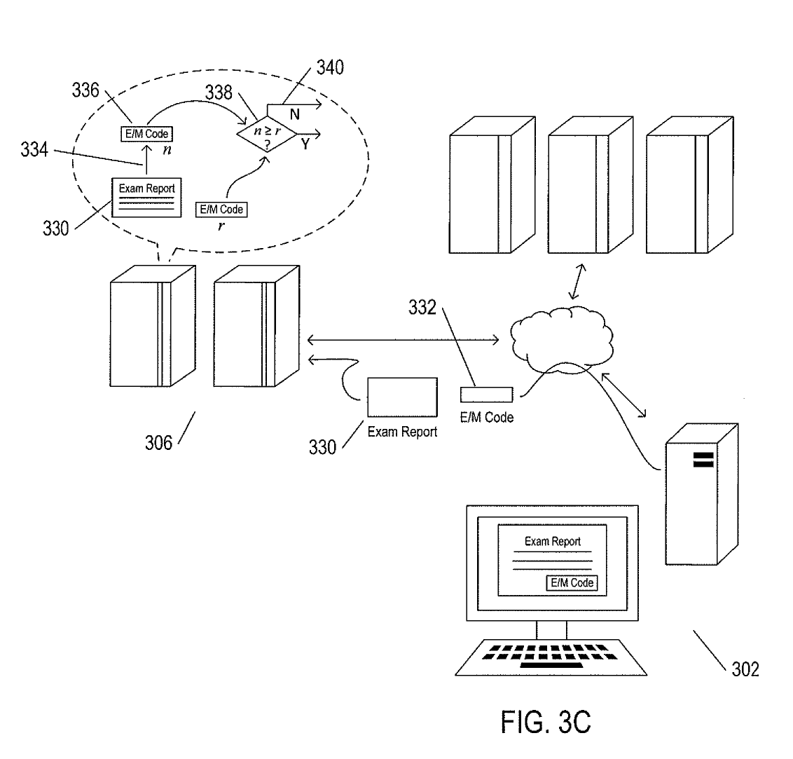

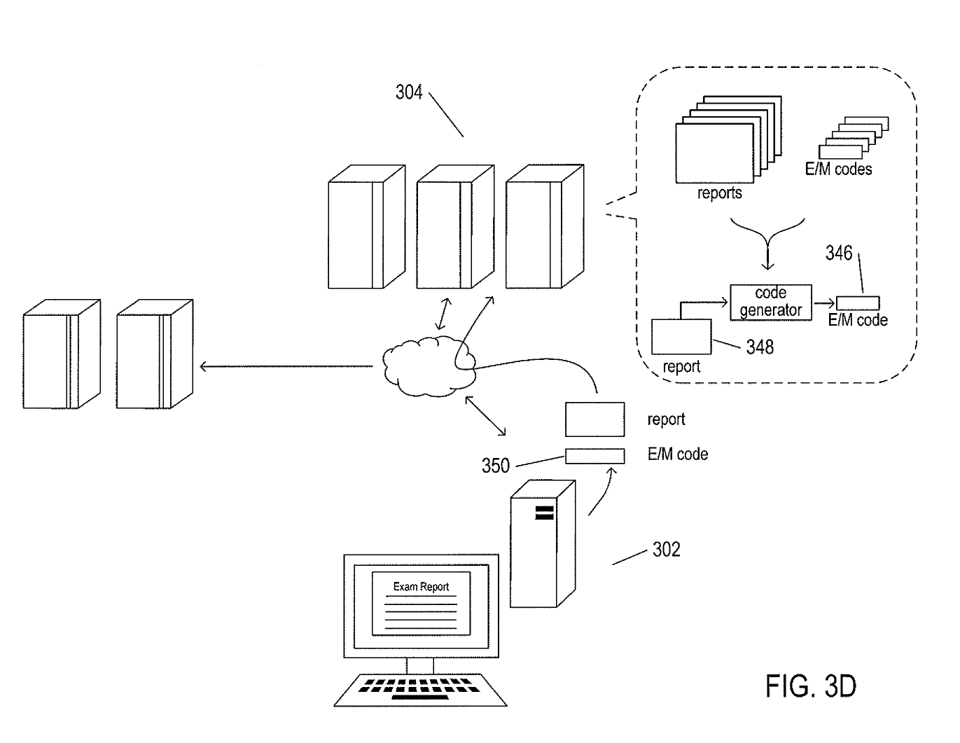

FIGS. 3A-D illustrate various ways in which the currently described automated methods and systems that generate E/M codes can be used in real-world environments. In FIG. 3A, a simple real-world environment is illustrated. This real-world environment includes a computer within a medical-services-provider facility 302, a cloud-based service system 304, and an insurance computer system 306. All three computer systems are interconnected by the Internet 308.

FIG. 3B illustrates one real-world application of the currently disclosed automated methods and systems for generation of E/M codes. In FIG. 3B, a physician has either manually entered an exam report 308 into the provider system or has attached a dictation device to the provider system from which an audio file has been downloaded and transcribed into an exam report 308, displayed on a display device 310 of the provider computer system 302. Previously, the physician, or an employee of the physician or a medical center in which the physician works, would need to consult complex rules in order to determine an E/M code to associate with the exam report and forward both the exam report and the E/M code to an insurance provider for payment. However, when an automated E/M-code-generation method is incorporated within the cloud-based service system 304, a medical information system on the provider system 302 can securely forward the exam report, as indicated by curved arrow 312, to the service system 304 which, in turn, analyzes the exam report, or medical document, to generate a corresponding E/M code 314 that is returned to the provider system, as indicated by curved arrow 316, for association with the medical document 308. This E/M code can then be forwarded by the provider system to the insurance computer system 306, as indicated by curved arrow 318, along with the medical document 308, in order to complete an insurance claim for reimbursement for provided medical services. Thus, one significant application of the E/M-code-generation methods and systems described below is as a third-party ELM-code-generation system that can be accessed by medical-services-provider systems to obtain automated E/M-code generation. Automated RIM-code generation by third-party systems provides significant advantages to medical providers. First, because the RIM-code-generation service can train models based on data provided by a large number of medical-services providers, the E/M-code-generation service is generally able to achieve levels of reliability and accuracy that would not otherwise be obtained by individual service providers or individual medical centers. The E/M-code-generation service clearly saves significant time that would otherwise need to be devoted to E/M-code generation by service-provider personnel. In addition, the E/M-code-generation service, as an independent third-party service, may add an indication that the E/M code was generated by the third-party service, rather than the individual service provider, to lend increased credibility to the E/M code provided by the medical-services provider to the insurance company. Alternatively, the E/M-code generation methods may be incorporated into medial-services-providers' computer systems. They may locally develop models for code generation or access models developed remotely.

Another application of the automated methods and systems for generating E/M codes is for use in auditing claims, as shown in FIG. 3C. In this example, the medical-services-provider system 302 forwards a medical document 330 and an associated E/M code 332 to the insurance system 306. The insurance system employs automated E/M-code generation, as represented by arrow 334, to independently generate an E/M code 336 for the medical document 330. The auditing system within the insurance computer system then compares 338 the E/M code locally generated by the insurance computer system to the E/M code forwarded to the insurance system by the medical-services provider. When the level-of-care code component of the locally generated E/M code is not greater than or equal to the level-of-care code component of the E/M code submitted by the medical-services provider, as determined by comparison 338, the insurance computer system may carry out additional processing, as represented by arrow 340, to determine whether or not the submitted E/M code represents an inadvertent miscoding or may represent an attempt to fraudulently claim provision of a greater and more expensive service than justified by the submitted medical document. The auditing subsystem within the insurance computer system may carry out many additional types of analyses based on comparison of the locally computed E/M code and the E/M code submitted by medical-services providers. These analyses may result in identification of incorrectly designed and implemented medical-services-provider information systems, inconsistent application of E/M-code-generation rules, and other types of systematic problems within components of the medical-billing systems that cooperate to furnish claims to the insurance company.

Yet another application of the automated E/M-code-generation methods and systems is for use in developing computational models for use in automated E/M-code generation, as illustrated in FIG. 3D. In computational model training, the E/M-code-generation service 304 collects sets of medical documents associated with correctly generated E/M codes from various sources, potentially including medical-services providers 302. The E/M-code-generation service independently and locally generates E/M codes 346 for the submitted medical documents 348. Discrepancies between the locally generated E/M codes 346 and the submitted E/M codes 350 can be used to adjust the computational models used in E/M-code generation, as discussed, in detail, below. Thus, automated E/M-code generation can be applied within an E/M-code-generation-service system to constantly update and improve the computational models that the E/M-code-generation service uses to generate E/M codes. As mentioned above, the E/M-code-generation service 304 may generate E/M codes on behalf of remote clients or may provide models for E/M-code generation to remote medical-billing systems.

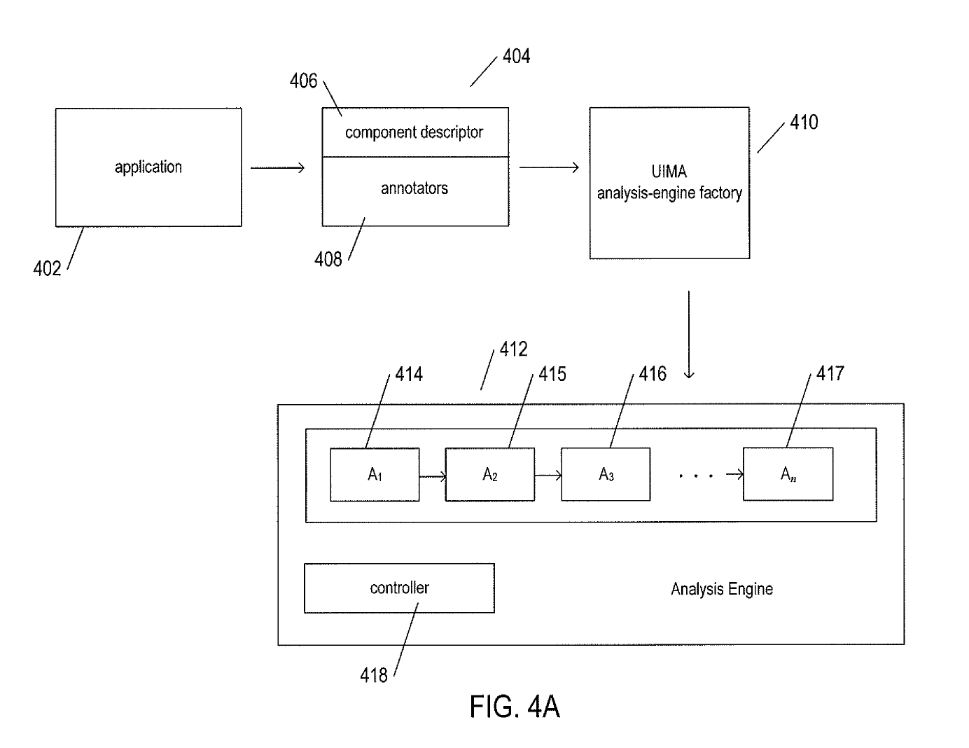

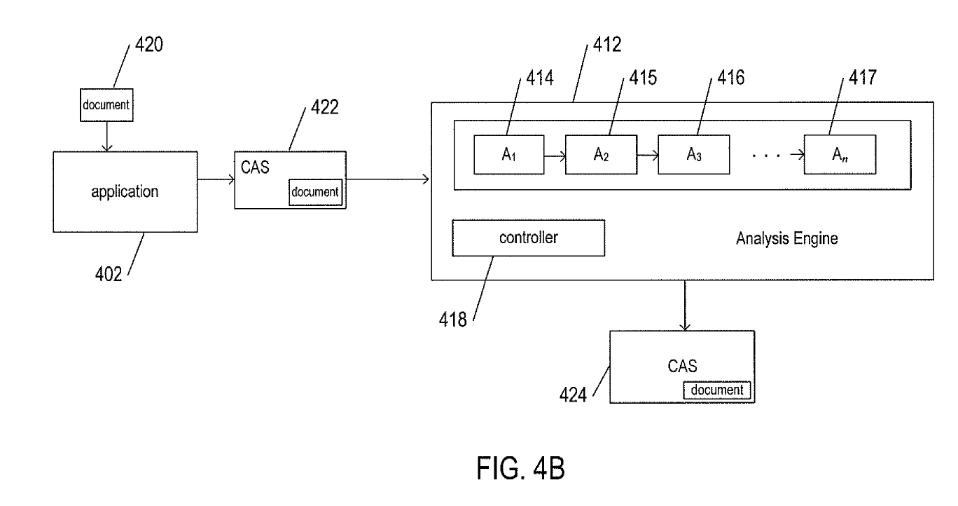

FIGS. 4A-B illustrate the unstructured-information-management (“UIM”) approach used to implement an E/M-code-generation system as one example of E/M-code-generation-system implementations. The UIM architecture is a generalized architecture for creating applications that interpret large amounts of unstructured data. As shown in FIG. 4A, an application program 402 creates a description of desired unstructured-information processing 404 that includes a component descriptor 406 and class files that implement one or more annotators 408. The annotators are processing units that carry out specific processing tasks with respect to a document containing unstructured information. The description of the desired processing 404 is submitted to a UIM architecture (“UIMA”) analysis-engine factory 410, which uses the descriptions and implementations contained in the processing description 404 to instantiate an analysis engine 412. The analysis engine can be thought of as a sequence of one or more instantiated annotators 414-417 and a controller 418 that controls sequential processing, by the annotators, of an input document to produce annotations and higher-level constructs associated with the document that represent various concepts and features extracted from the document. The UIMA provides a large number of data types, library routines, and additional functionality that allows the annotators to be straightforwardly implemented above a rich set of already-implemented functionalities and provides for instantiation of an analysis engine 412 to which the application 402 can interface in order to process a document.

FIG. 4B illustrates document processing using the analysis engine instantiated by the UIMA. The application program 402, such as an E/M-code-generation subsystem within an E/M-code-generation-service computer system, receives a document 420, such as a medical document for which an E/M code needs to be generated. The application 402 embeds the document in a common analysis structure (“CAS”) data structure 422 and submits the CAS data structure to the analysis engine 412 for processing. The CAS data structure 422 is an object-based data structure that provides for representation of objects, properties, and values. The CAS includes numerous already-defined object types and provides for extension of these initially provided object types into a rich type system. The various types include objects that represent annotations, concepts, and other such information-representing objects. The CAS data structure 422 is operated on by each of the annotators 414-417, with the processing by the annotators controlled by the controller 418 functionality of the analysis engine. Once all of the annotators have competed their processing tasks, an output CAS data structure 424 is returned to the application program, which can then use the annotation and concept objects that represent interpretation of the contents of the document, as well as additional types of objects created during analysis-engine processing, for application-specific purposes. In the current document, the application uses the information contained in the output CAS data structure 424 to generate an E/M code for the input medical document 420.

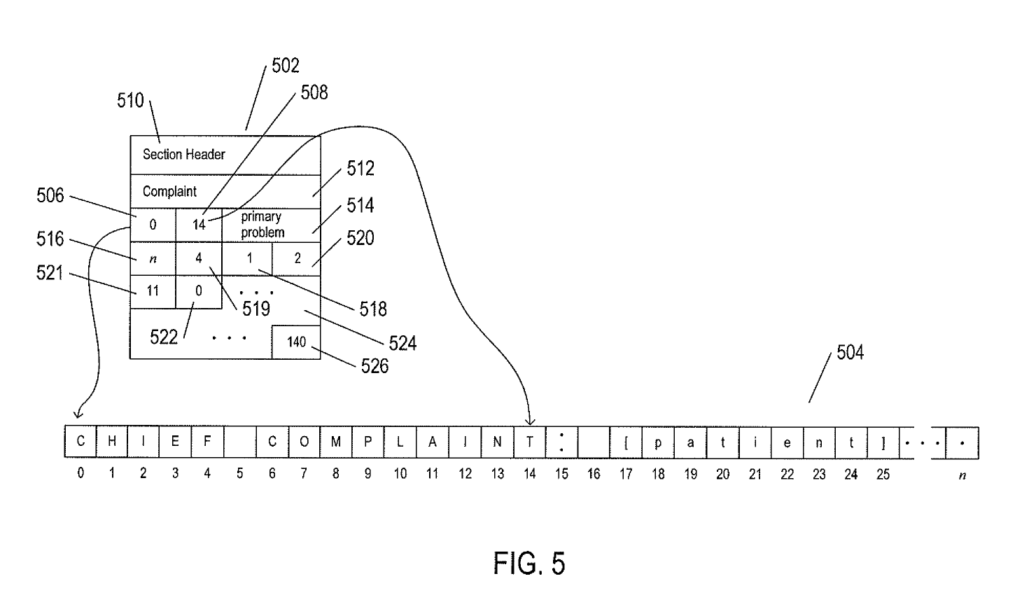

FIG. 5 illustrates an example annotation object that may be instantiated by an annotator within an analysis engine. In this case, the annotation object 502 represents a section header within the example medical object 202 shown in FIG. 2A. The annotation object 502, like the majority of annotation objects produced by an analysis engine, is associated with a representation 504 of the document that is analyzed by the analysis engine. In this case, the document is represented as an array of text characters. The section object 502 is associated with the document 504 by two pointers, or reference fields 506 and 508 within the section-header object. The first pointer 506 points to the first character of a character substring that is annotated by the section-header object and the second reference field or pointer 508 points to the final character of the substring annotated by the section object. The section-header object 502 includes a type field 510, a section category field 512, a field containing an additional characterization of the section 514, a field that indicates the number of characters in the substring annotated by the object 516, five fields 518-522 that indicate the number of low-level annotations, each of which is associated with one or more contiguous characters within the section entitled by the section header represented by the section object 502, additional fields not shown in FIG. 5 524, and a final field 526 that indicates the number of words in the section entitled by the section header represented by the section object 502. Of course, the contents of a section-header object may vary with different implementations. In alternative implementations, the section-header object may be much simpler and may be referenced by a higher-level section concept object that includes the fields 514, 516, 518-522 and 526 included in the section-header object 502.

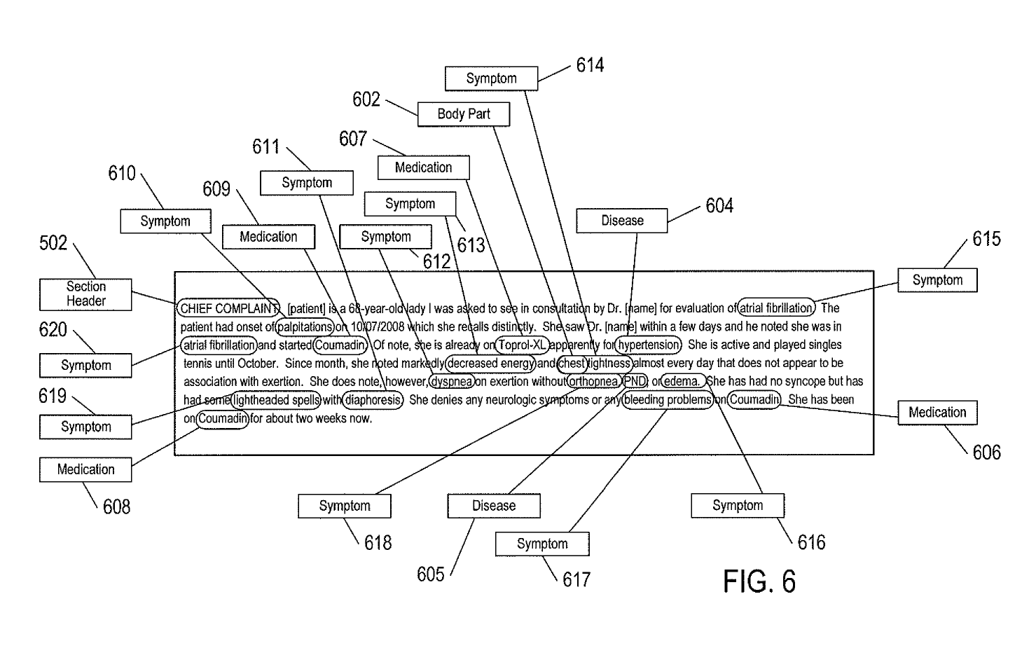

FIG. 6 illustrates certain of the low-level annotation objects instantiated by the analysis engine to which an E/M-code-generation subsystem interfaces. The low-level annotation objects include a section-header object 502, discussed above with reference to FIG. 5, a body-part annotation object 602, which points to a substring that describes an anatomical feature, two disease annotation objects 604-605, each of which annotates a substring that represents a particular type of disease, four medication annotation objects 606-609, each of which annotates a substring that represents a pharmaceutical or other type of medication, and 11 symptom annotation objects 610-620, each of which annotates a substring that represents a symptom. These annotation objects are instantiated by one or more annotators within the annotation engine that process words and phrases within the document and match the words and phrases to entries in medical dictionaries, in certain implementations. Many other types of low-level annotation objects may be instantiated during document processing by the analysis engine. The additional types of annotation objects may include annotation objects for various grammatical features of the document, including sentences and paragraphs, annotation objects related to formatting of the document, such as sections and regions or chapters, and many additional types of annotation objects.

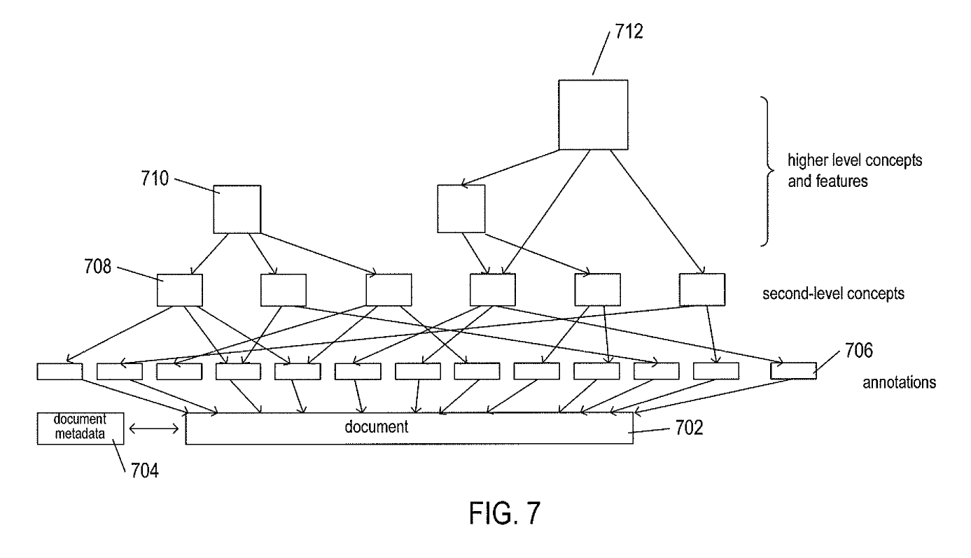

FIG. 7 illustrates the logical output of an analysis engine that is represented by an output CAS data object (424 in FIG. 4B). As mentioned above with reference to FIG. 5, the document itself 702 is embedded in, or referenced from, the CAS data object. Document metadata 704 may be associated with the document and may include one or more key/value pairs extracted from the document by one or more of the annotators within the analysis engine. Document metadata generally includes information such as the name of an attending physician, the date of the performed medical service, an insurance group number, and other such information. As discussed above, a set of low-level annotations, such as low-level annotation 706, are associated with the document. These low-level annotations may include grammar, formatting, and term or phrase annotations. In addition, certain of the low-level annotations may be considered to be low-level concept objects, such as particular term or phrase annotations that correspond to symptoms, body parts, diseases, procedures, medications, and other such simple medical concepts. The CAS data structure may contain additional levels of concept objects, including second-level concept objects, such as second-level concept object 708, third-level concept objects, such as third-level concept object 710, and additional levels of concept objects. As shown in FIG. 7, the higher-level concept objects may reference lower-level concept objects and/or lower-level annotations. In the case of a E/M-code-generation-application CAS data object, a highest-level object 712 may be a features object that includes feature/value pairs, each of which includes the name of a combination of one or more lower-level objects and a numeric value associated with the feature. For example, one type of feature may represent the number of times that a concept selected from a particular set of concepts occurs in the text of the document or in a section of the document. Features may include any of a large number of derived parameters or metrics based on low-level concepts, annotations, and other information contained in instantiated objects associated with the document in the output CAS data structure. Thus, in certain implementations, an E/M-code-generation subsystem includes an application program that executes on one or more computer systems and that interfaces with an instantiated analysis engine. The application program receives documents, incorporates the received documents into CAS data structures, inputs the CAS data structures into an analysis engine instantiated by a UIMA framework, receives corresponding output CAS data structures that include a variety of instantiated information objects that represent various types of information identified by annotators of the analysis engine within the document, and then uses the information objects included in the output CAS data structure to generate E/M codes for the documents.

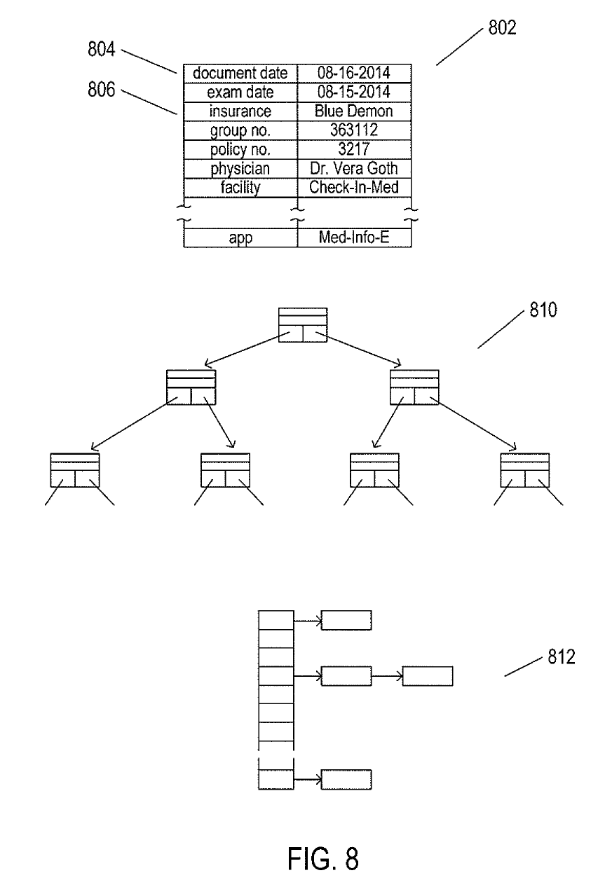

FIG. 8 illustrates an implementation of a metadata object (704 in FIG. 7) associated with a processed document by an analysis engine. Logically, the metadata object is a set of metadata/value pairs 802. Example metadata/value pairs include a document-date/numeric-date pair, shown in the first row 804 of the two-column table 802 representing metadata/value pairs. Another example is an insurance/insurance-name metadata/value pair represented by the third row 806 in table 802. In general, each metadata/value pair is a pair of strings, the first string of the pair indicating the particular metadata represented by the pair and the second string of the pair representing the value of the particular metadata represented by the pair.

In certain implementations, this logical set of metadata/value pairs is stored as a map. Maps may be implemented as binary trees 810 or as a set of hash values and corresponding hash buckets 812. Either of the tree-based or hash-based implementations of the map allow the value string of a metadata/value pair to be quickly and efficiently found based on the metadata identifier of the metadata/value pair. In the binary-tree implementation 810, the metadata identifier is used to search the tree until a node corresponding to that metadata identifier is located. The value is extracted from the node. In the hash-based map 812, a function is applied to the metadata identifier in order to generate a hash value, and the hash value is looked up to identify a bucket containing the value corresponding to the metadata identifier. Of course, the metadata object may be implemented in many additional ways, including as a simple list of metadata-identifier/value pairs stored in a flat file or as metadata-identifier/value pairs stored in a relational-database table. A list implementation is particularly appropriate when only a small number of metadata-identifier/value pairs are extracted from a given document.

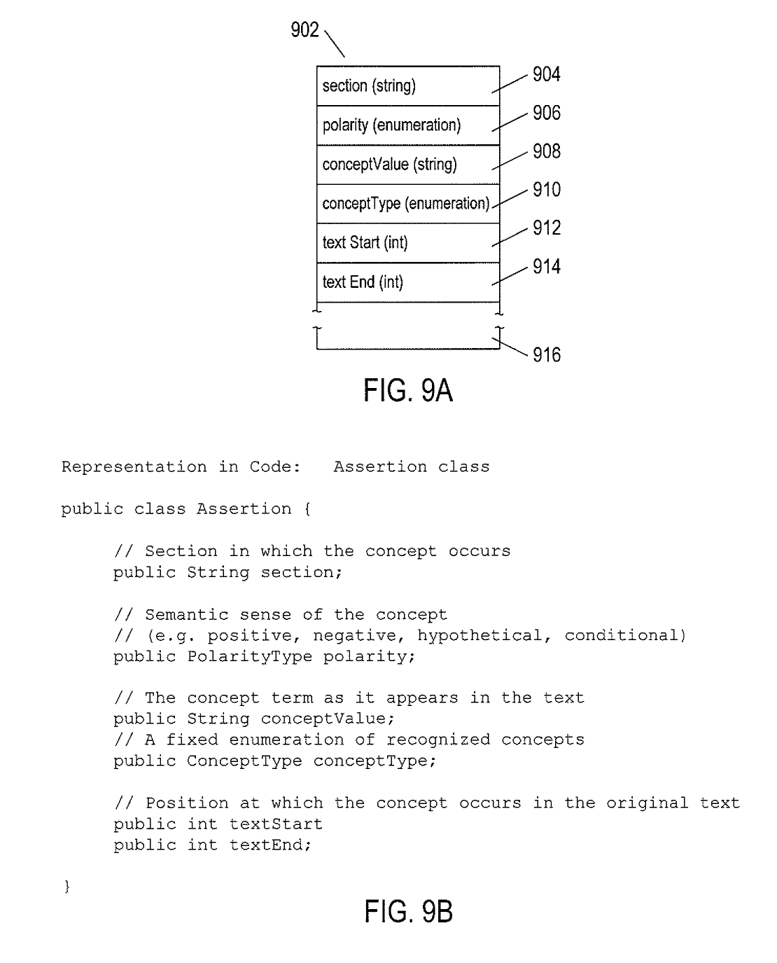

FIGS. 9A-B illustrate one implementation of a concept object. In this implementation, a concept object is an instantiation of an assertion class. As shown in FIG. 9A, the concept object includes fields, or data members, that identify the section in which the substring annotated by the concept object occurs 904, a polarity associated with the concept 906, a string value for the concept 908, a type value for the concept 910, and integers that represent the starting point 912 and ending point 914 of the substring annotated by the concept object within the document. The concept object 902 may additionally contain various function members 916, such as get and set functions for the various data members. FIG. 9B shows a portion of the declaration of the assertion class for one implementation of an E/M-code-generation subsystem.

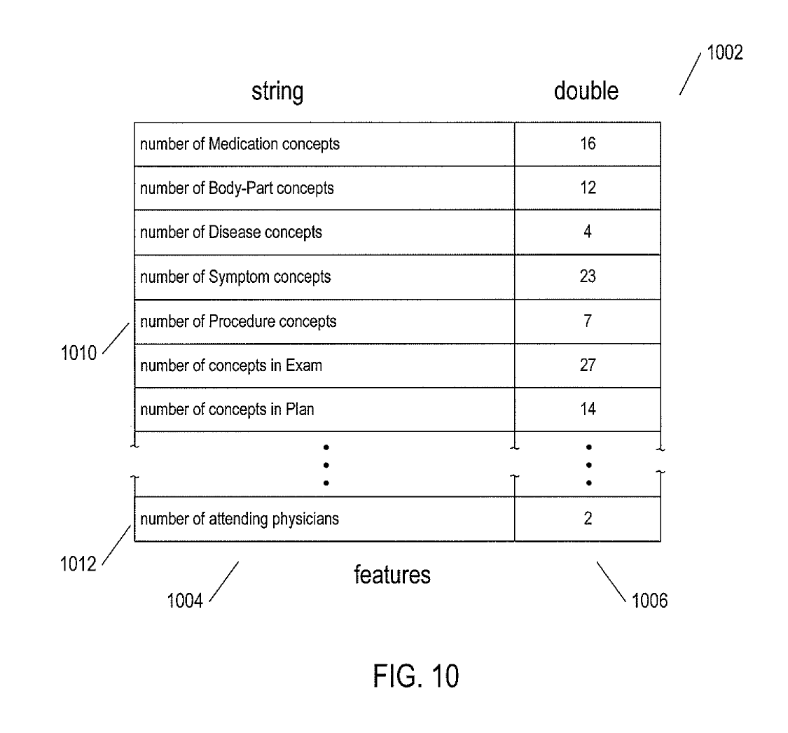

FIG. 10 illustrates a features object that includes a set of features extracted from a document, generally by one or more annotators within an analysis engine or, in alternative implementations, by functionality within an E/M-code-generation application that processes a CAS data structure returned by an analysis engine. The features data object includes extracted feature names and feature values. In other words, the features data object contains a set of feature-name/feature-value pairs. The example features data object 1002 shown in FIG. 10 uses strings for the feature names and floating point numbers for the feature values. The feature names are shown in the first column 1004 of a tabular representation of the features data object and the feature values are shown in a second column 1006 of the tabular representation of the features object 1002. Example features include the number of procedure concepts contained in the medical document, represented by the feature/value pair in row 1010 of the tabular representation of the features object, and the number of attending physicians, represented by row 1012 of the tabular representation of the features object. The features object may be implemented as a list of feature/value pairs, as a map, or in many additional ways.

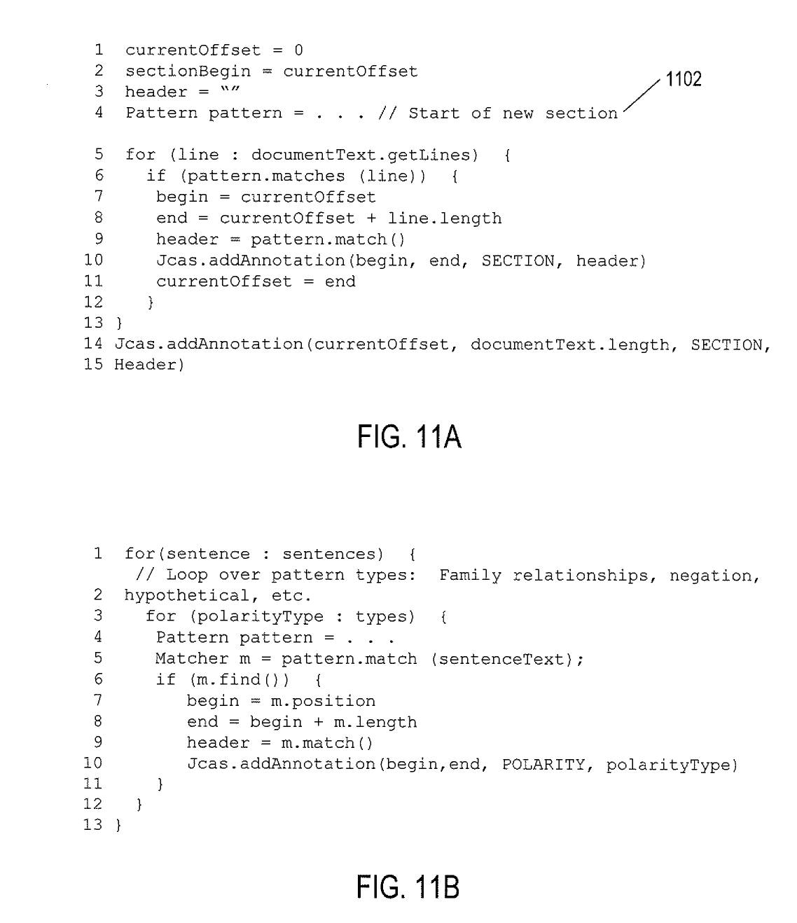

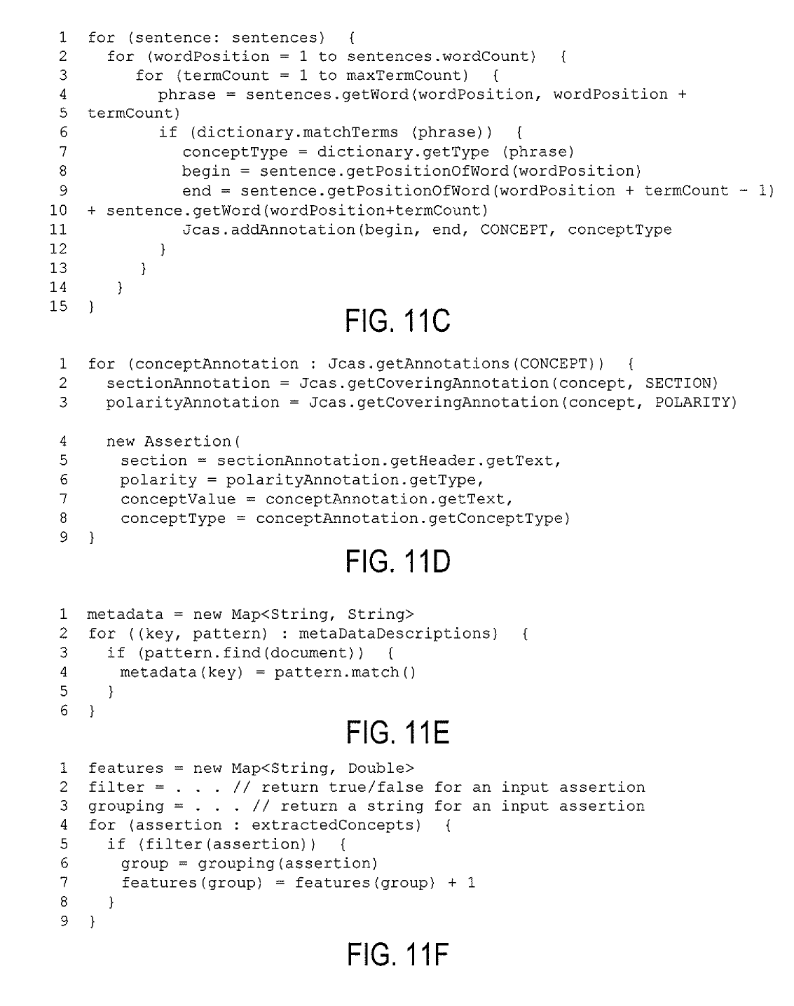

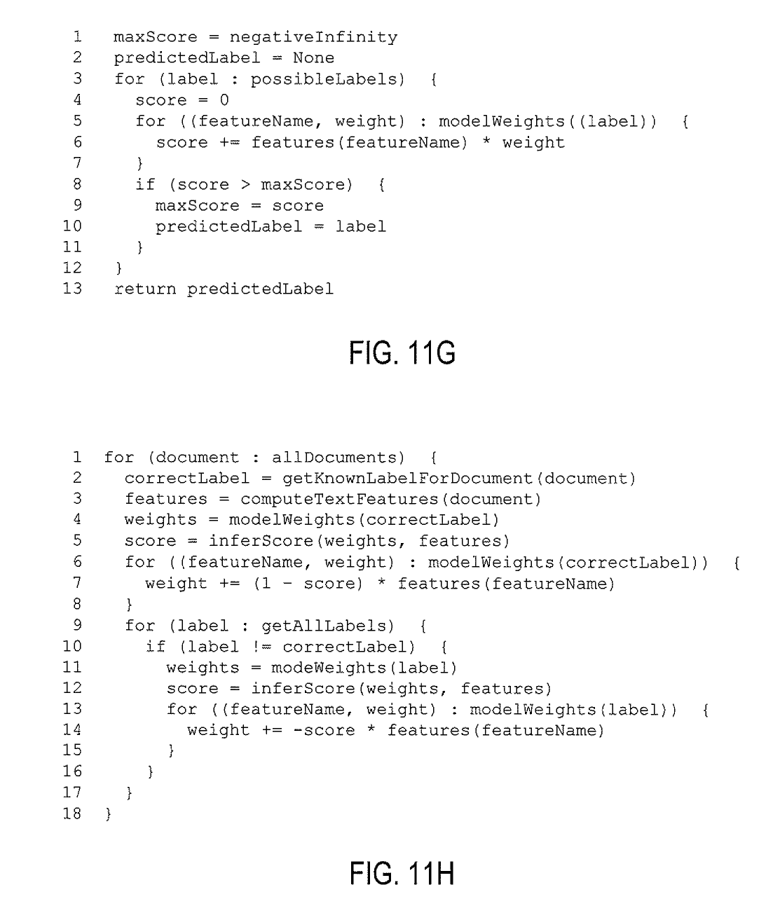

FIGS. 11A-H provide pseudocode illustrations of the logic included in various annotators instantiated within an analysis engine to which certain implementations of an E/M-code-generation subsystem interfaces. FIG. 11A provides pseudocode for the annotator which instantiates section-header annotation objects. The annotator recognizes the start of a new section using a pattern, declared on line 4 1102. Details of the pattern are not shown in the pseudocode, since the actual pattern used depends on the organization and formatting conventions employed in the medical documents that are being annotated. In a for-loop of lines 5-13, the annotator considers every line within the text of the medical document. When the section-header pattern matches the currently considered line, as determined on line 6, the annotator determines the starting and ending characters of the current line and then instantiates a section-header annotation object, on line 10, to annotate the current line. Of course, in various different implementations, the details illustrated in the pseudocode example shown in FIG. 11A may differ. For example, in certain systems, the annotation object for a section header may span the entire section, rather than only the line that contains the section heading, or may alternatively span only a substring within the current line that actually includes the section title. As discussed above, a section-header may be a low-level annotation object with only a type field and reference fields or may contain many additional fields in which values are later stored once remaining low-level annotations objects have been instantiated.

FIG. 11B provides a code that illustrates instantiation of polarity annotation objects. Polarity annotation objects annotate certain words and phrase that significantly affect or alter the semantic meaning of a concept proximal to their locations in the medical document. For example, the phrase “not present” preceding a substring annotated by a concept object is considered to be a negative-polarity phrase that renders the concept as being absent or negated. Similar negative-polarity terms include “denies” and “absent.” The pseudocode shown in FIG. 11B is similar to pseudocode shown in FIG. 11A. In an outer far-loop of lines 1-13, each sentence in the medical document is considered. In an inner for-loop of lines 3-12, each type of polarity term or phrase is considered. A pattern for the polarity type is attempted to be matched to the currently considered sentence on line 5. When a match occurs, as determined on line 6, a polarity annotation object is instantiated to reference the term or phrase recognized as a polarity term or phrase.

FIG. 11C provides a pseudocode example of annotator logic used to annotate low-level concepts within a medical document. In the outer loop of lines 1-15, each sentence in the medical document is considered. In an intermediate-level for-loop of lines 2-14, each word position within the currently considered sentence is considered. In an innermost for-loop of lines 3-13, each phrase of between 1 and a maximum number of terms, maxTermCount, beginning with the currently considered word position is considered. When the currently considered term or phrase is found in a dictionary, as determined on line 6, then a concept annotation is instantiated to annotate the phrase, on line 11.

FIG. 11D provides pseudocode that illustrates instantiation of next-level concept objects. In the for-loop of lines 1-9, each low-level concept annotation is considered. On lines 2 and 3, the section annotation and any polarity annotation that include the currently considered lower-level concept annotation are identified. Then, on lines 4-8, a next-level concept object is instantiated. The next-level concept object includes field values that identify the section and polarity associated with the concept.

FIG. 11E illustrates instantiation of a metadata object for a medical document. On line 1, a new metadata object is created. Then, in the for-loop of lines 2-6, for every metadata key value, the logic attempts to match a pattern for the corresponding metadata value in the medical document. When a matching value is found, the key/value pair is added to the metadata object, on line 4.

FIG. 11F illustrates the instantiation of a feature object by an annotator within an analysis engine. On line 1, a new feature object is created. On lines 2 and 3, a filter and grouping object are initialized. The filter object filters concept objects to select only those concept objects relevant to a particular feature. The grouping object selects one or a combination of attributes related to a concept object that meets the filter criteria. Then, in the for-loop of lines 4-9, all of the concept objects instantiated for a medical document are considered. Those which meet the filter requirements, as determined on line 5, are subject to the grouping object in order to identify a particular feature to which the concept object is relevant. Then, on line 7, the value associated with that feature is incremented. The pseudocode shown in FIG. 11F thus updates count values for particular features that can be identified by a particular filter and grouping combination. Multiple feature objects can be created, by one or more annotators of an analysis engine, to accumulate feature values for features described by multiple filter/grouping combinations. Alternatively, additional for-loops may be introduced into the pseudocode shown in FIG. 1 IF to iterate over multiple filter/grouping combinations in order to include many different types of features within a single feature object.

FIG. 11G provides pseudocode that identifies a particular code, referred to as a “label” in the pseudocode, based on features and corresponding feature values. This logic can be used to identify levels for assignment to key components and the patient-type/service portion of an E/M code. In the outer for-loop of lines 3-12, all possible labels, or codes, are considered. In the inner for-loop of lines 5-7, a score is computed for the currently considered label by summing the product of feature values with corresponding model weights. Thus, the score is computed as the sum of weighted feature values. The label that produces the highest score is selected as the label, or code, for a medical document that has been processed to produce the set of feature values used in the computation of the scores for each label. The weights that multiply the feature values together comprise a model for code assignment that is generally obtained, as discussed below, by a computational training process. Computation of scores as sums of weighted feature values is but one possible method for computing scores. In alternative methods, any of many different types of polynomial expressions that include feature-value-based terms may be used, including expressions in which terms are raised to powers other than 1. Additional non-polynomial score-computation methods can be alternatively used. The general approach, however, is common to these different types of score-computation processes. The feature values associated with features computed for a medical document are used to compute scores for possible labels, and the label with the most favorable score is selected as the label corresponding to the medical document. In the current case, the score with the largest numerical magnitude is the most favorable score. In alternative approaches, the score with the smallest numerical magnitude may be the most favorable score. In yet additional types of scoring methods, a score closest to a particular value or range of values may be selected as the most favorable score.

FIG. 11H provides a pseudocode example of a computational training process used to establish model weights by which labels are selected using the label-selection approach discussed above with reference to FIG. 11G. In an outer for-loop of lines 1-18, each document in a set of training documents that are associated with correct E/M codes is considered. On line 3, the feature values for the currently considered document are computed. On line 5, a score is computed for the correct label for the document based on current model weights for the correct label by the method discussed above with reference to FIG. 11G. Then, in a for-loop of lines 6-8, the model weights for the correct label are adjusted by adding the value (1−score)*feature_value to the model weights. In other words, the weights for the model for the correct label are increased in proportion to the magnitudes of the feature values for the medical document. The adjustment and weights carried out in the for-loop of lines 6-8 tend to produce scores in the range of [0,1]. Then, in the for-loop of lines 9-17, the model weights associated with all of the other, incorrect labels are decreased by a factor (−score)*feature_value. Thus, the weights corresponding to features are decreased in proportion to the feature values of the features for the currently considered medical document. Thus, training involves increasing the weights corresponding to features of the model corresponding to the correct code for a medical document and decreasing the weights corresponding to features of the models for incorrect codes.

As discussed further, below, more complex model training methods may be used in alternative implementations. As one example, following weight adjustments, another step may be employed to further constrain the weights in order to ensure that scores produced by the scoring process, discussed above with reference to FIG. 11G, fall within the range [0,1]. As another example, in implementations in which multiple codes may be assigned to a particular medical document, a collection of codes that produce the most desirable scores may be selected for a particular document and the training method may adjust the model weights for the multiple codes upward and adjust the model weights for all of the codes downward. Model-weight adjustments may, in alternative implementations, be non-linear.

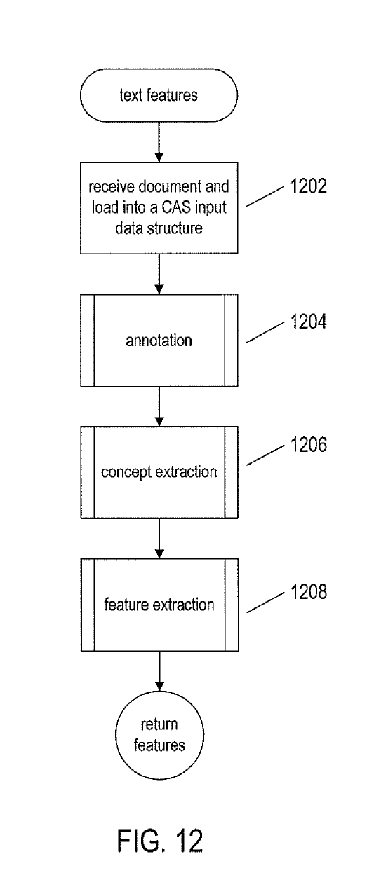

FIGS. 12-27 provide control-flow-diagram illustrations of the currently described E/M-code-generation methods and systems, certain data structures, and applications of E/M code generation. FIG. 12 provides a control-flow diagram for a routine “text features” that extracts a set of feature/feature-value pairs from a medical document. In step 1202, the routine “text features” receives a medical document and incorporates the medical document into a CAS input data structure, as discussed above with reference to FIG. 4B. In step 1204, a routine “annotation” instantiates annotation objects and low-level concept objects that reference substrings within the medical document. In certain implementations, the routine “annotation” represents processing carried out by one or more annotators within a UIMA analysis engine, as discussed above, with reference to FIG. 4A. In step 1206, the routine “concept extraction” is called to generate additional levels of concept objects based on the annotation objects and low-level-concept objects instantiated by the routine “annotation.” The higher-level concept objects are discussed above with reference to FIG. 7. Pseudocode provided in FIG. 11D illustrates instantiation of higher-level concept objects. In step 1208, the routine “feature extraction” is called to instantiate one or more feature objects, as discussed above with reference to FIG. 7 and FIG. 10.

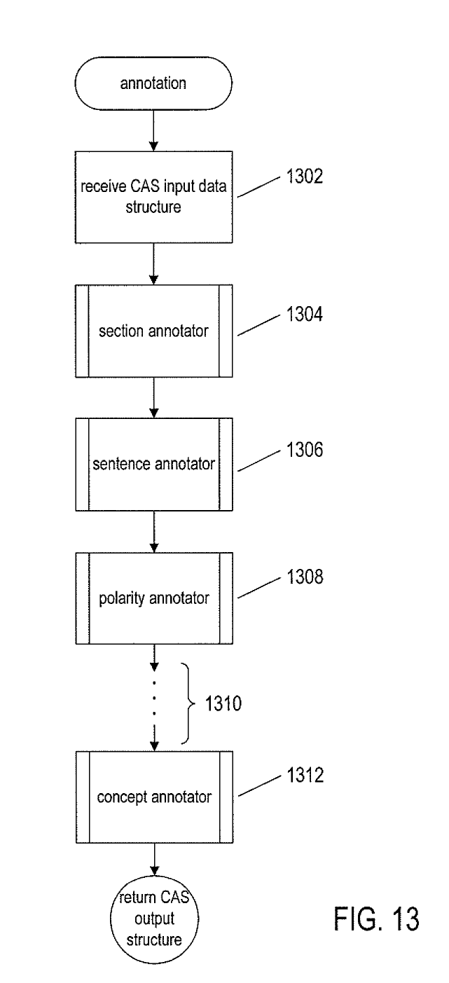

FIG. 13 provides a control-flow diagram for the routine “annotation,” called in step 1204 of FIG. 12. In step 1302, the routine “annotation” receives a CAS input data structure that references, or includes, a medical document. In step 1304, the routine “annotation” invokes a section annotator to instantiate section-header annotation objects, as discussed above with reference to FIG. 11A, FIG. 5, and FIG. 6. In step 1306, the routine “annotation” calls a routine “sentence annotator” to instantiate sentence annotation objects. In step 1308, the routine “annotation” calls a routine “polarity annotator” to instantiate polarity annotation objects, as discussed above with reference to FIG. 11B. Ellipsis 1310 indicates that additional annotators may be invoked by the routine “annotation” in order to instantiate additional types of annotation objects, including additional grammar-related annotation objects, formatting-related annotation objects, and term/phrase annotation objects. Finally, in step 1312, the routine “annotation” calls a routine “concept annotator” in order to instantiate low-level concept objects, as discussed above with reference to FIG. 11C.

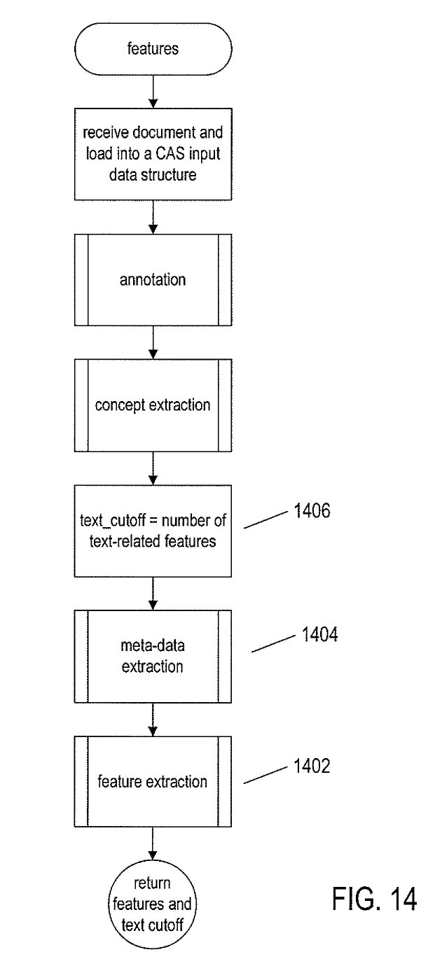

FIG. 14 provides a control-flow diagram for a routine “features.” This routine is similar to the routine “text features” illustrated in FIG. 12, with the exception that feature extraction carried out by the call to the routine “feature extraction” in step 1402 extracts feature/value pairs not only from various levels of annotation and concept objects, as in the case of the routine “text features,” but also from one or more metadata objects that are instantiated by a call to a routine “metadata extraction” in step 1404. Feature extraction is discussed above with reference to FIG. 1 IF and metadata extraction as discussed above with reference to FIG. 11E. In addition, the routine “features” sets a parameter text cutoff, in step 1406, to the number of text-related features, which are first extracted by the call to the routine “feature extraction” in step 1402. The routine “features” thus extracts a superset of the features extracted by the routine “text features.” The routine “features” extracts the same text-related features as extracted by the routine “text features” but additionally extracts features related to extracted metadata.

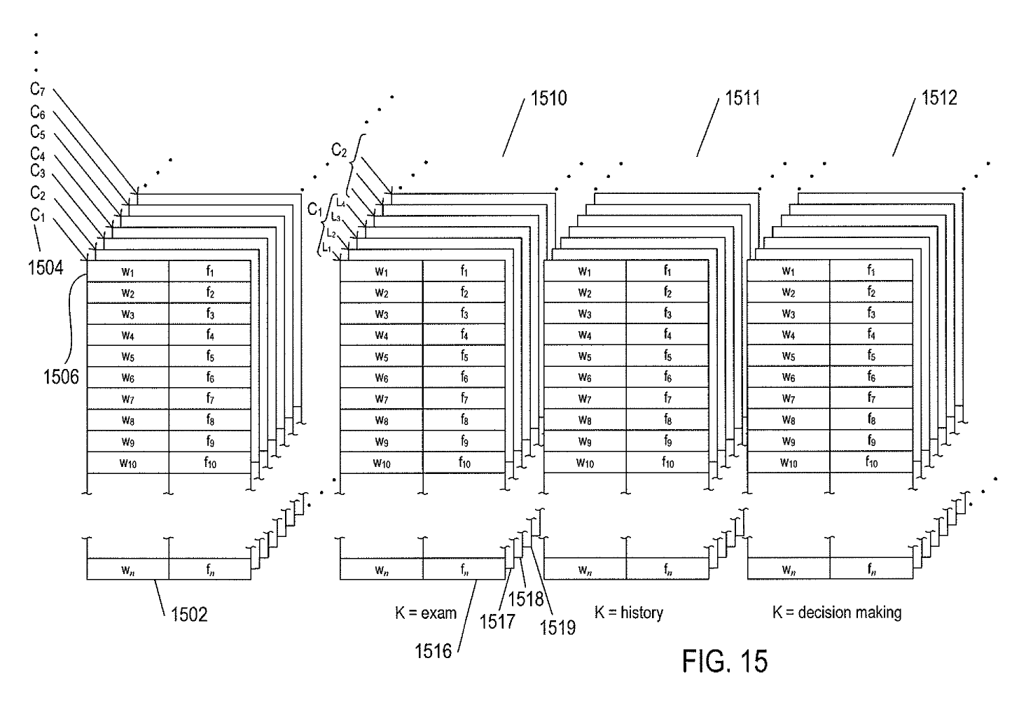

FIG. 15 illustrates the model weights used, in certain implementations of the E/M-code-generation methods and systems, to generate scores for E/M codes, including the patient-type/service portions of the E/M codes and the level of care components of the E/M codes. For each different patient-type/service code, represented in FIG. 15 as C₁, C₂, . . . , there is a table of weights, such as the table of weights 1502 associated with patient-type/service code C₁ 1504. Each table of weights includes a set of weight/feature pairs, such as the weight/feature pair represented by the first row 1506 in table 1502. Each feature extracted by the above-discussed routine “features” is associated with a weight in each table associated with a different patient-type/service code. Scores for patient-type/service codes are computed from feature values for features extracted from a medical document that include text-based features as well as metadata features.

The model weights also include sets of tables for each of the key components 1510-1512. In the example shown in FIG. 15, each key component can have one of four different levels. Therefore, there is a weight table associated with each different level for each of the different patient-type/service codes for each of the key components. Thus, the first four tables 1516-1519 in the set of tables for key-component exam 1510 correspond to the four different levels L₁, L₂, L₃, and L₄ for patient-type/service code C₁. The key-component weight tables are similar to the patient-type/service code tables, with the exception that the key-component weight tables include weights only for text-related features.

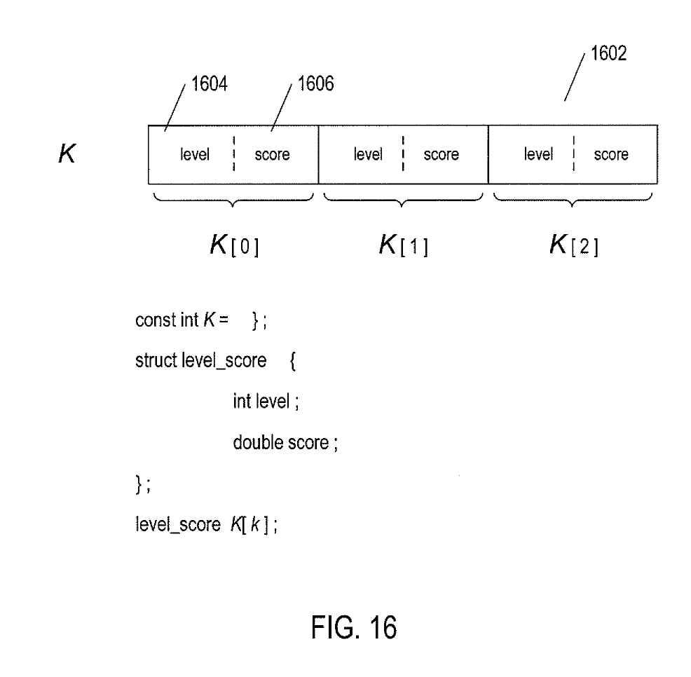

FIG. 16 illustrates a data structure K returned by a routine, discussed below, that determines the level values for each of the key components for a medical document. The data structure K 1602 includes a level value and an associated score for each of the three key components. For example, for key component 0, the exam-related key component, the data structure K contains a level value 1604 and an associated score 1606.

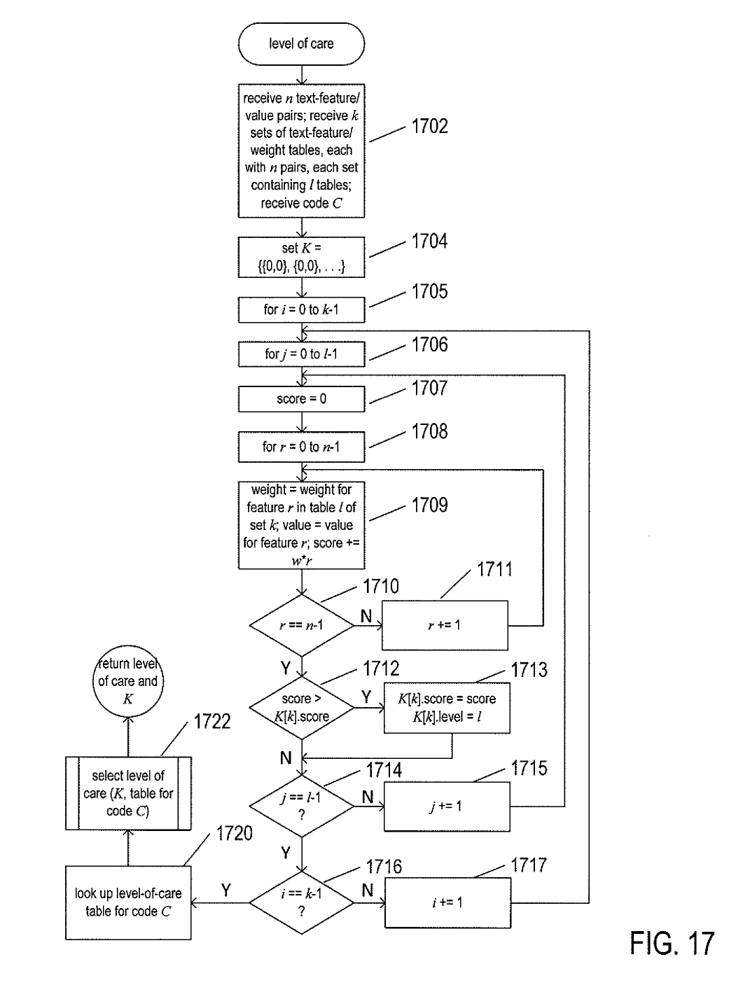

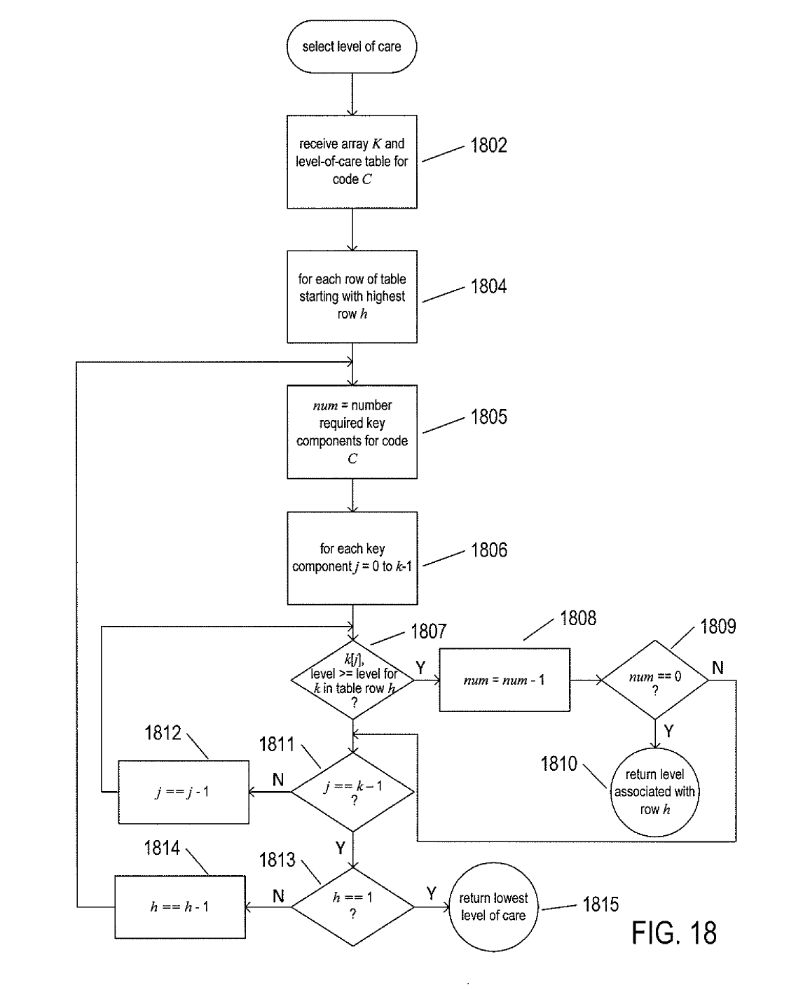

FIGS. 17-18 illustrate the determination of a level-of-care code component for a particular input medical document based on the code-determination pseudocode discussed above with reference to FIG. 11G. In step 1702, the routine “level of care” receives n text-feature/value pairs and sets of weight tables for each of the key components, discussed above with reference to FIG. 15. In addition, the routine “level of care” receives a patient-type/service code C. In step 1704, the data structure K, discussed above with reference to FIG. 16, is initialized to contain all 0 values. In the nested for-loops of steps 1705-1717, the routine “level of care” considers each possible level for each of the key components. In step 1707, a local variable score is set to 0. Then, in an innermost for-loop of steps 1708-1711, a score is computed for the currently considered level of the currently considered key component by summing terms for each of the features, each term the product of a feature weight, obtained from a weight table, and a feature value obtained from a feature object instantiated by an analysis engine and discussed above with reference to FIG. 10. When the score for the currently considered level and key component is greater than a score saved in the K data structure, as determined in step 1712, then the K data structure is updated to include the currently considered level and the just-computed score, in step 1713. In this fashion, the level for each K component that produced the greatest score is selected and stored, along with the score, in the K data structure. Next, in step 1720, the routine “level of care” looks up the level-of-care table for the patient-type/service code C such as the level-of-care table shown in FIG. 2C. Then, in step 1722, the routine “level of care” selects a level-of-care code component for the medical document associated with the feature values used to compute the key-component/level scores stored in the data structure K by calling a routine “select level of care.”

FIG. 18 provides a control-flow diagram for the routine “select level of care” called in step 1722 of FIG. 17. In step 1802, the routine “select level of care” receives the data structure K, prepared by the routine “level of care,” and the level-of-care table for the code C. In the for-loop of steps 1804-1814, the routine “select level of care” considers each row, starting with the row with highest index, of the level-of-care table. In step 1805, a local variable num is set to the number of required key components for assigning a level-of-care code corresponding to the table row to the medical document. Then, in the inner for-loop of steps 1806-1812, the routine “select level of care” determines whether or not at least num key components have been assigned levels that are at least equal to the levels in the currently considered row of the level-of-care table. If so, the level-of-care level for the medical document corresponding to the currently considered row is returned, in step 1810. Otherwise, the lowest level of care value is returned in step 1815.

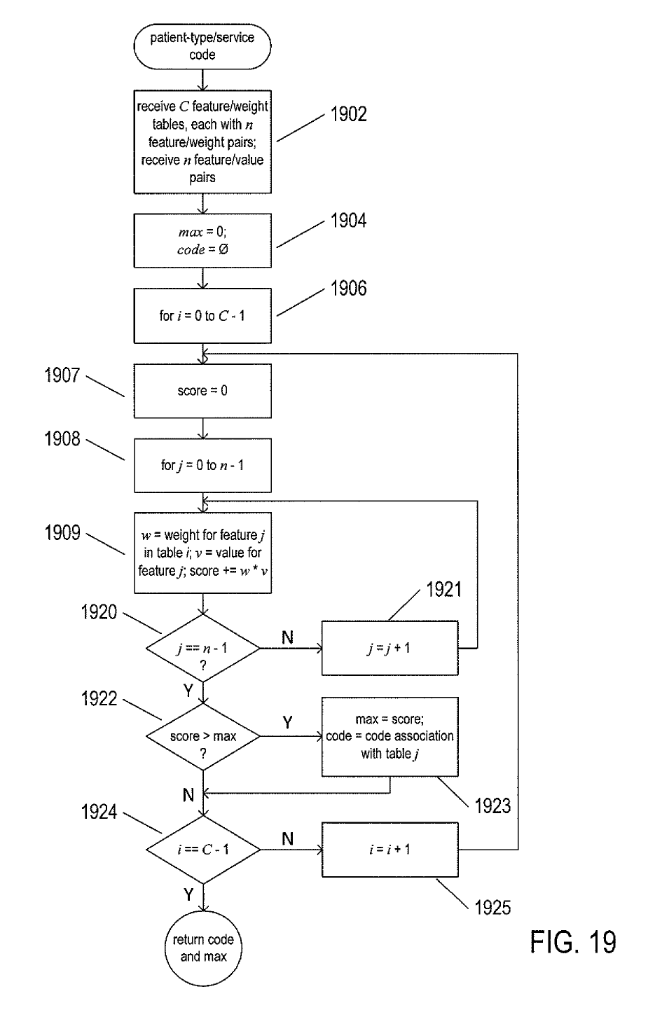

FIG. 19 illustrates computation of a patient-type/service code for a medical document by a routine “patient-type/service code” using the general approach discussed above with reference to FIG. 11G. In step 1902, the feature/weight tables for each possible patient-type/service code are received, along with the feature/value pairs computed for a particular medical document. In step 1904, local variables max and code are set to 0. Next, in the for-loop of steps 1906-1925, the routine “patient-type/service code” computes a score for each possible patient-type/service code and selects, as the patient-type/service code corresponding to the medical document from which the feature/value pairs were computed, the patient-type/service code that produces the greatest score.

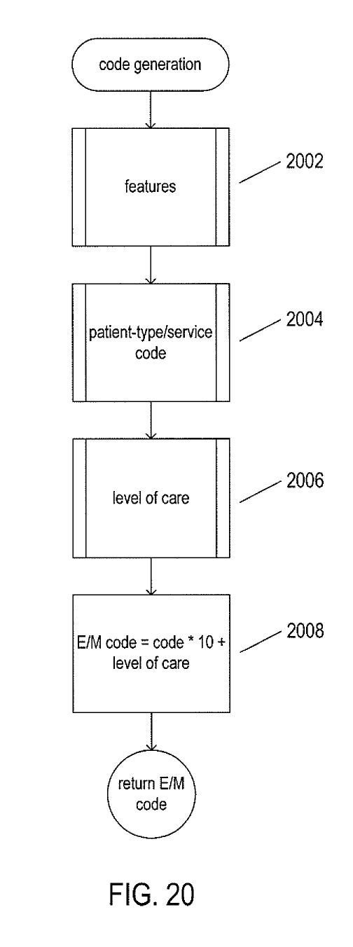

FIG. 20 provides a control-flow diagram for a routine “code generation” which determines an E/M code for an input medical document. In step 2002, the routine “code generation” calls the routine “features,” discussed above with reference to FIG. 14, in order to instantiate one or more feature objects that each includes a set of feature/feature-value pairs extracted from the medical document, in many implementations by an analysis engine that includes multiple annotators. In step 2004, the routine “code generation” calls the routine “patient-type/service code,” discussed above with reference to FIG. 19, in order to determine the patient-type/service code for the input medical document. In step 2006, the routine “code generation” calls the routine “level of care,” discussed above with reference to FIGS. 17-18, to compute the level-of-care code component for the input medical document. Finally, in step 2008, the routine “code generation” combines the patient-type/service code and level-of-care code component as discussed above with reference to FIG. 2A, into a final E/M code which is returned by the code-generation routine.

As discussed above with reference to FIGS. 3A-D, the routine “code generation” may be run as a component of an E/M-code-generation-service computer system that provides E/M codes for medical documents submitted by medical-services-provider computer systems. Alternatively, the routine “code generation” may be run as a component of a medical-services-provider information system.

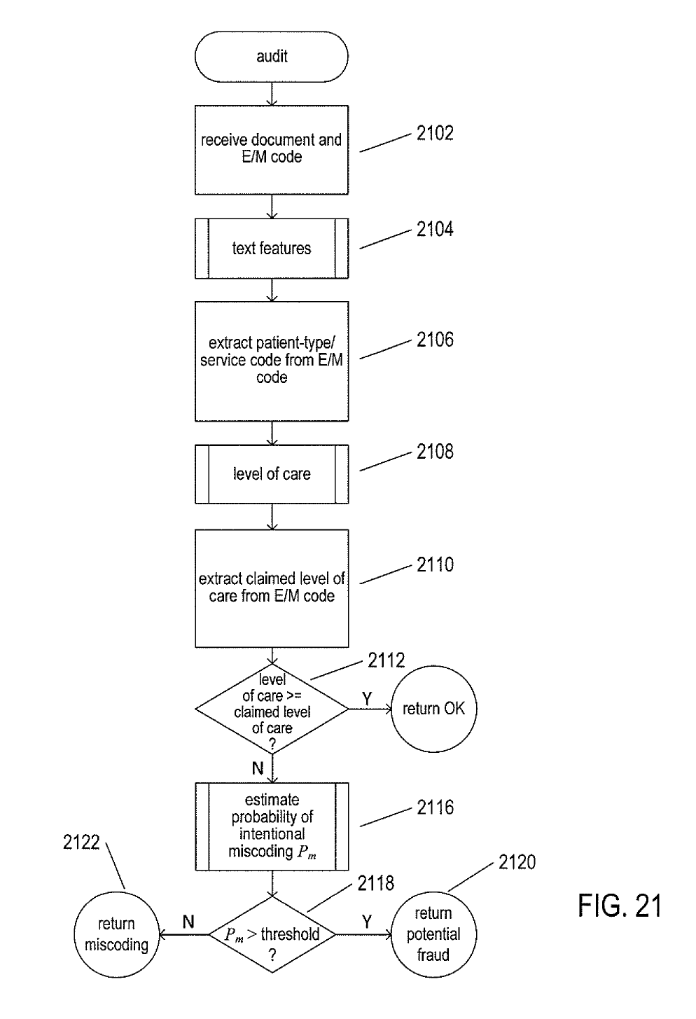

FIG. 21 provides a control-flow diagram for a routine “audit” that is executed, in an insurance-company computer system, as discussed above with reference to FIG. 3C, in order to determine whether or not a submitted level-of-care code component is correct, inadvertently miscoded, or constitutes potential billing fraud. In step 2102, the routine “audit” receives a medical document and corresponding E/M codes from a medical-services provider. In step 2104, the routine “audit” calls the routine “text features,” discussed above with reference to FIG. 12, to compute the feature values for a set of text features. In step 2106, the routine “audit” extracts the patient-type/service code from the received E/M code. In step 2108, the routine “audit” computes a level of care for the received document via a call to the routine “level of care,” discussed above with reference to FIGS. 17-18. In step 2110, the routine “audit” extracts the claimed level-of-care code component from the received E/M code. In step 2112, the routine “audit” compares the computed level of care with the claimed level of care. When the two level-of-care values are identical, an indication of a correct E/M code is returned in step 2114. Otherwise, in step 2116, the routine “audit” calls one or more routines to estimate the probability that the received E/M code is the product of intentional miscoding. When the computed probability is greater than a threshold value, as determined in step 2118, then an indication of potential fraud is returned in step 2120. Otherwise, an indication of inadvertent miscoding is returned in step 2122.

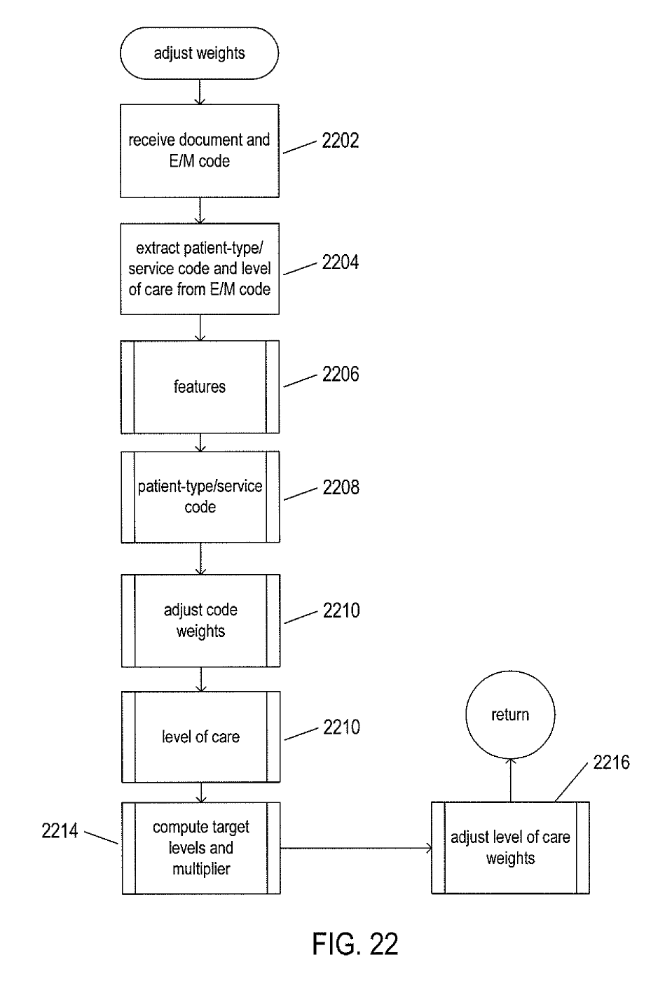

FIGS. 22-26 illustrate one implementation of a model-building method that is used, as discussed above with reference to FIG. 3D, for model building by an E/M-code-generation service. FIG. 22 provides a control-flow diagram for a routine “adjust weights” that adjust the model weights for code determination based on a particular medical document associated with an accurate E/M code. In step 2202, the routine “adjust weights” receives the medical document and E/M code. In step 2204, the routine “adjust weights” extracts the patient-type/service code and level-of-care component code from the received E/M code. In step 2206, the routine “adjust weights” calls the routine “features,” discussed above with reference to FIG. 14, to extract feature values from the received medical document. In step 2208, the routine “adjust weights” calls the routine “patient-type/service code,” discussed above with reference to FIG. 19, to compute a patient-type service code for the medical document. In step 2210, the routine “adjust weights,” calls the routine “adjust code weights,” discussed below, which adjusts the model weights for each possible patient-type/service code. In step 2212, the routine “adjust weights” calls the routine “level of care,” discussed above with reference to FIGS. 17-18, to compute a level-of-care code component for the received medical document. In step 2214, the routine “adjust weights” calls a routine “compute target levels and multiply them,” discussed below, to determine the levels for the key components in a multiplication factor and, in step 2216, calls a routine “adjust level of care weights,” discussed below, that uses the computed target levels and multiplier to adjust the level-of-care weight models.

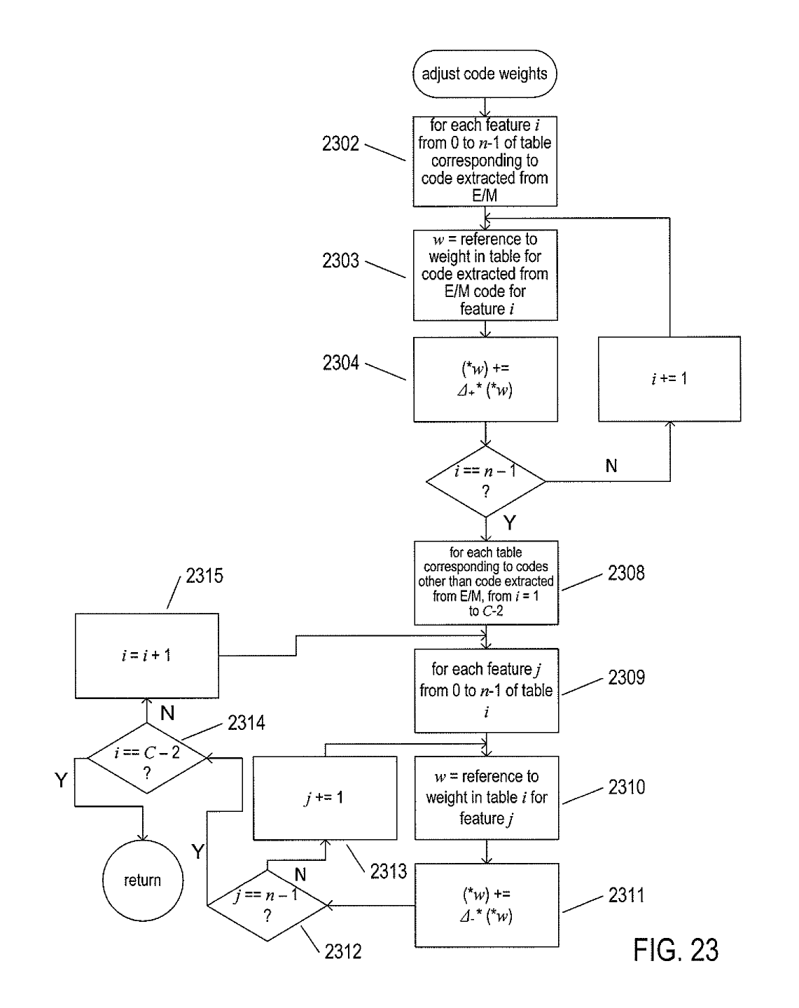

FIG. 23 provides a control-flow diagram for the routine “adjust code weights,” called in step 2210 of FIG. 22. FIG. 23 illustrates, using control-flow-diagram illustration conventions, the approach discussed above with reference to FIG. 11H. In a first for-loop of steps 2302-2306, the weights for the feature/weight pairs in the table for the code extracted from the E/M code are adjusted upward and in the for-loop of steps 2308-2315, the weights of the feature/weight pairs in the tables for all other patient-type/service codes are adjusted downward. In FIG. 23, the upward and downward adjustments include multipliers Δ₊ and Δ₋. In the pseudocode of FIG. 11H, these have the value (1−score) and (−score), respectively. However, other multipliers are possible, including multipliers computed with additional global constraints to ensure that scores fall in the range [0,1].

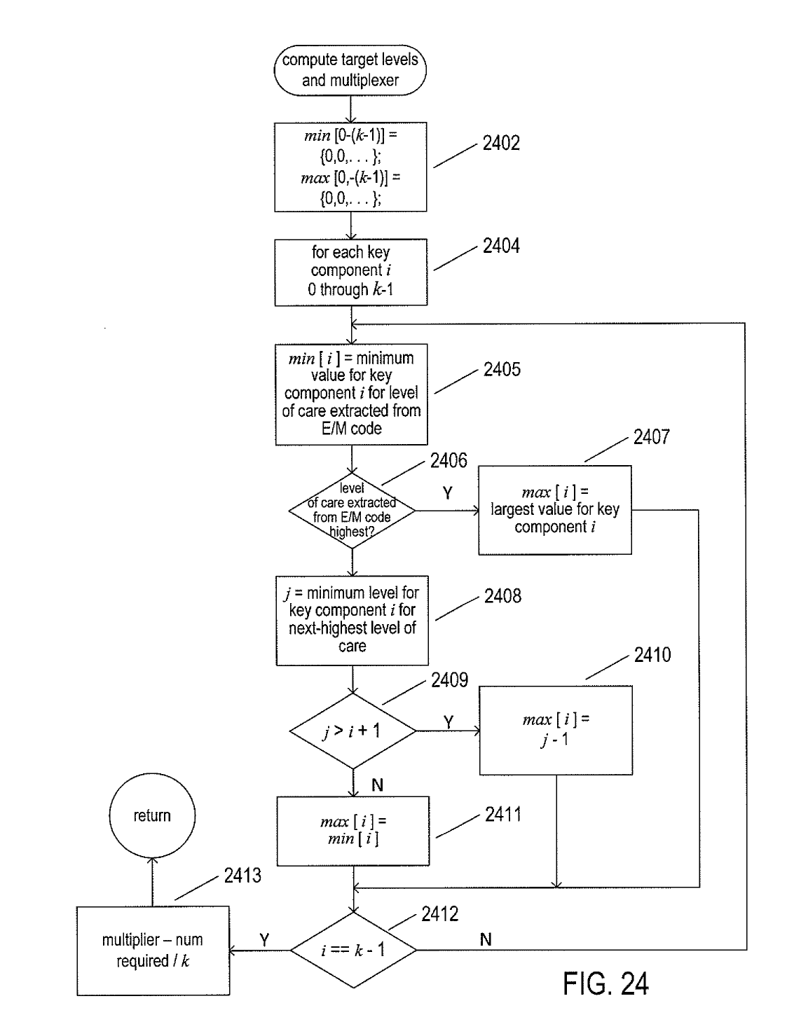

FIG. 24 provides a control-flow diagram for the routine “compute target levels and multiplier,” called in step 2214 of FIG. 22. In step 2402, this routine initializes an array min and an array max to all zeroes. The array min stores the lowest-level values for each of the key components and the array max stores the highest-level values for each of the key components that are compatible with the level of care code component extracted from the E/M code supplied with the medical document to the routine “adjust weights.” Then, in the for-loop of steps 2404-2412, the minimum and maximum levels for each key component are computed from the level-of-care table corresponding to the patient-type/service code extracted from the received E/M code. In certain cases, more than one level value for a key component is compatible with a particular value of the overall level-of-care code component. Then, in step 2413, a multiplier is computed as the ratio of the number of required key components to the total number of key components for assigning level-of-care values.

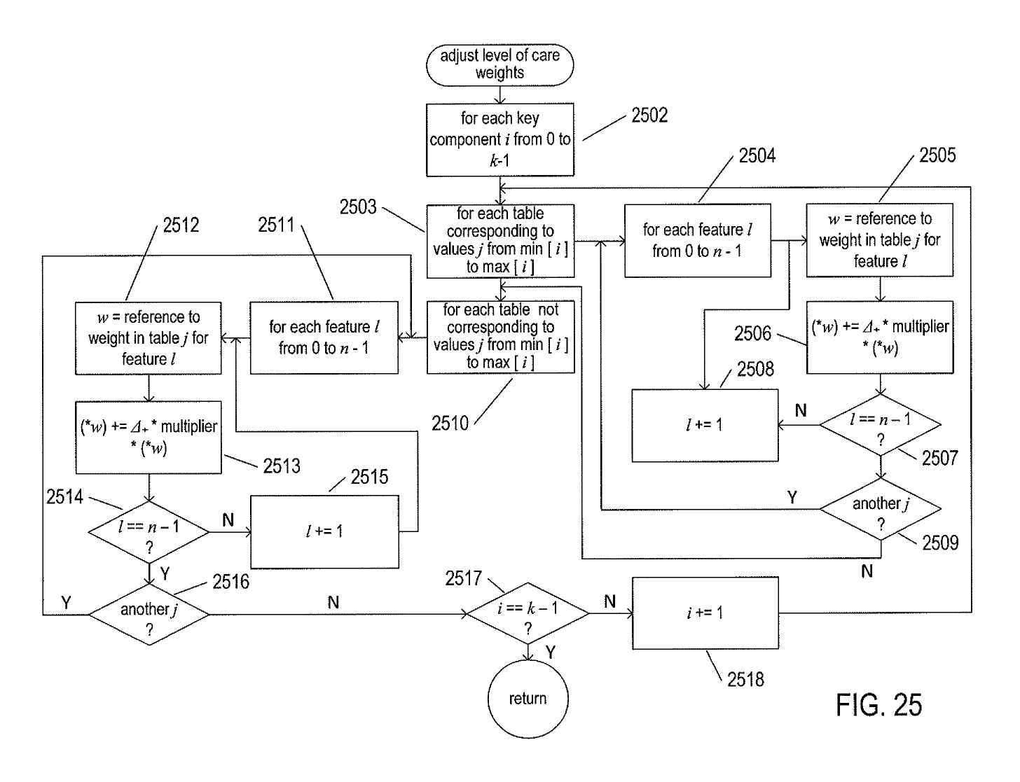

FIG. 25 provides a control-flow diagram for the routine “adjust level-of-care weights,” called in step 2216 of FIG. 22. This routine is similar to the routine “adjust code weights,” discussed above with reference to FIG. 23. However, positive weight adjustments are made for each of the possible target levels of each of the key components compatible with the level-of-care code component extracted from the supplied E/M code and negative weight adjustments are made for all remaining levels of each of the key components. In the outer loop of steps 2502-2518, each key component is considered. In the inner for-loop of steps 2503-2509, positive weight adjustments are made for the levels of the currently considered key component that are compatible with the level-of-care code component extracted from the supplied E/M code. In the inner for-loop of steps 2510-2516, negative adjustments are made for the weights in the tables for all remaining levels of the currently considered key component.

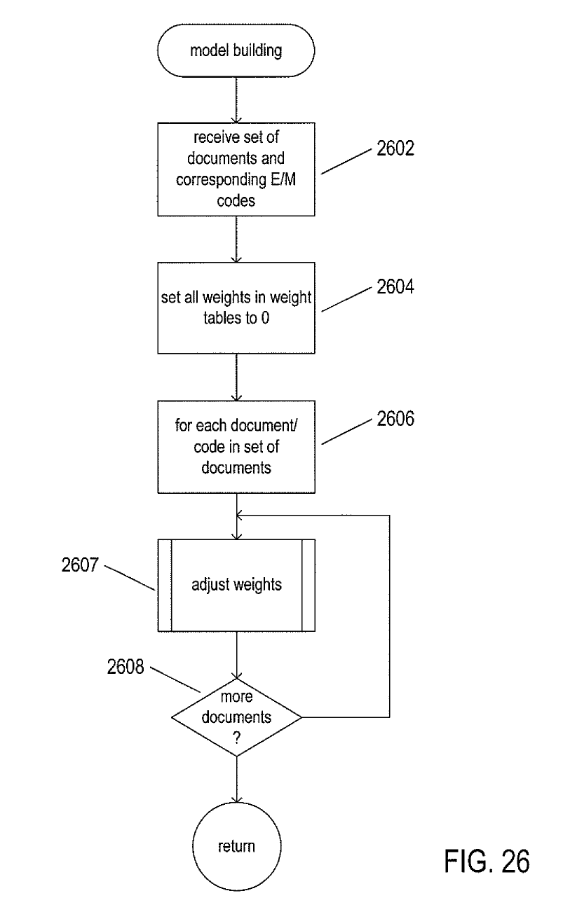

FIG. 26 provides a control-flow diagram for a routine “model building,” which receives a set of documents and corresponding correct E/M codes and develops a model based on the received documents and corresponding E/M codes. In step 2602, the routine “model building” receives the set of documents and corresponding E/M codes. In step 2604, the routine “model building” clears all of the weight tables for all patient-type/service codes and for all levels of all key components. Then, in the for-loop of steps 2606-2608, the routine “model building” calls the routine “adjust weights,” discussed above with reference to FIG. 22, to adjust the weight tables with respect to each of the received documents and corresponding E/M codes.

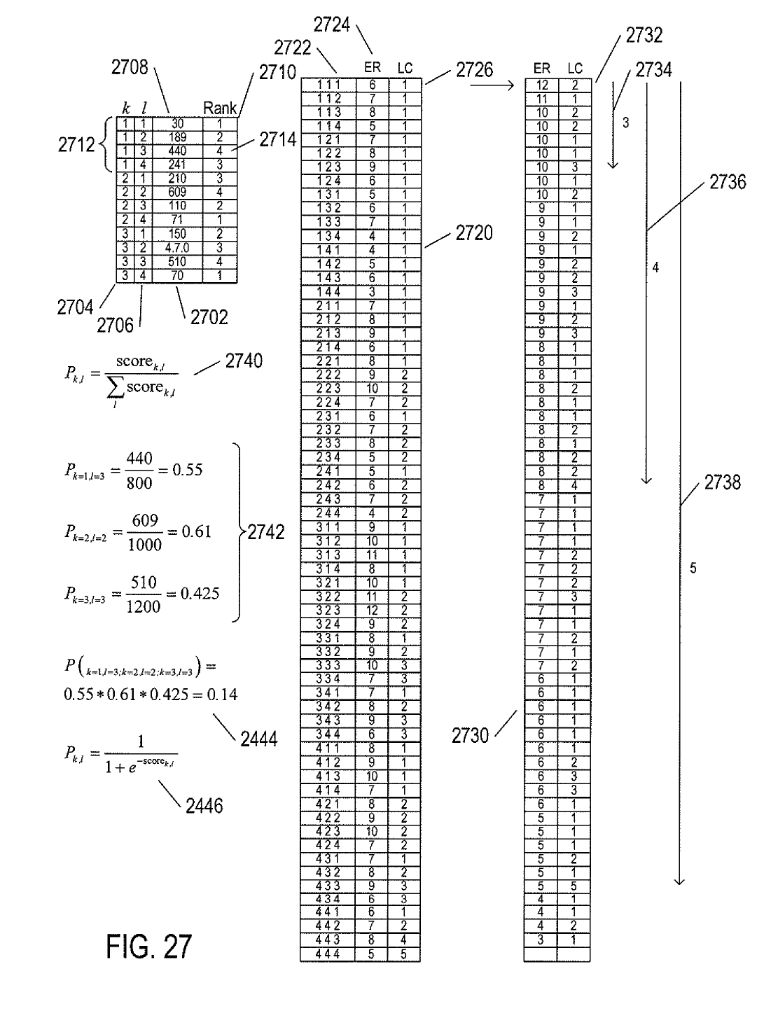

As discussed earlier with reference to FIG. 21, the routine “audit” estimates a probability of intentional miscoding in order to determine whether or not to flag a miscoded E/M code as being potentially fraudulent. FIG. 27 illustrates various possible ways of computing an indication to characterize the probability that an incorrect level of care has been inadvertently submitted in a billing request. One method is based on rank ordering. First, a table 2702 is prepared to list the computed scores for each level of each key component. In table 2702, a first column 2704 lists the numeric value for the key component, a second column 2706 lists the level of care, a third column 2708 lists the scores computed for the key component and level of care specified in the first two columns, and a final column 2710 computes a rank, based on the computed scores, for each level within each key component. For example, the first four rows of the table 2712 include the scores computed for each level for the first key component. The scores are used to rank the levels for the first key component. The highest-ranked row 2714 corresponds to the third level. Thus, during level-of-care code component calculation, the third level would be assigned to the first key component based on the computed scores. In a next table 2720, all possible level assignments for the three key components are considered, with each row of the table corresponding to a different assignment of levels to the three key components. The level assignments to the three key components are listed in a first column 2722 of table 2720. In a second column 2724, the sum of the ranks of the levels in the level assignment is listed. In a final column 2726, the level of care corresponding to the level assignments, based on the level-of-care table, is listed. In a third table 2730, values from the second table are re-ordered according to the ranked sums. The first row of the third table 2732 represents the computed level of care code component and its rank, based on the sum of the ranks of the scores for the levels assigned to the key components. The remaining entries in the third table list the level-of-care code components that would have been computed had different level assignments been made to the key components during the computation of the level-of-care code component. Downward-pointing vertical arrows, such as downward-pointing vertical arrow 2734, represent the shortest distance between the computed level of care represented by the first row of the third table and a particular larger-magnitude level of care. Determination of whether a miscoding may or may not be fraudulent can be made based on the length of these downward-pointing arrows or, in many cases, the ratio of the lengths of the downward-pointing arrows to the overall length of the table. For example, downward-pointing arrow 2734 is relatively short, and indicates that there is a relatively large probability of an inadvertent miscoding of that medical document to have a level of care of magnitude 3 rather than the correct level of care of magnitude 2. Downward-pointing arrow 2736 is significantly longer than downward-pointing arrow 2734, indicating that the probability of inadvertently miscoding the medical document to have a level of care of magnitude 4 is relatively low. Downward-pointing arrow 2738 is quite long, indicating that there is a very slight probability that a level-of-care code component with magnitude 5 would have resulted from inadvertent miscoding. Thus, in step 2116 of the routine “audit,” discussed above with reference to FIG. 21, the distance between the first entry in the third table and the first entry with the submitted level of care can be computed in order to determine the probability of miscoding. The ratio of the distance between the first entry and the first entry with the submitted level-of-care code-component value, or the ratio of this distance to the overall table size, may be used as an estimate of the probability of intentional miscoding. A rank-ordering-based probability estimate has the advantage of not assuming an underlying distribution for the computed level-of-care code-component magnitudes. A variety of more sophisticated rank-order statistical methods can be applied in order to compute a probability of intentional miscoding in addition to the empirical method illustrated in FIG. 27.

In another approach, also illustrated in FIG. 27, the probability that a particular key component is assigned a particular level, P_{k,l}, can be computed as the score for the assignment of level l to key component k divided by the sum of all of the scores for all levels for key component k 2740. In the example data provided in table 2702, the probabilities of the correct level assignments for the three key components based on the greatest scores are computed as 0.55, 0.61, and 0.425, respectively 2742. The probability that the three correct level assignments are made during E/M coding can therefore be computed as 0.14 2744 using the level-of-care table shown in FIG. 2C. The probability of miscoding is then 0.86. More complex calculations can be carried out to determine the probability of an observed erroneous level-of-care code component, which can be used directly or indirectly to determine the probability of potential fraud.

In yet another approach, a probability distribution parameterized by the computed score for a level assignment to a key component can be used to compute the probabilities of level assignments to key components 2446. These computed probabilities can then be used, as the computed probabilities 2740 are used, to compute the probability that an erroneous level-of-care code component was computed inadvertently.

There are, in addition to the methods outline in FIG. 27, many other possible ways for estimating the probability that a miscoding of the level-of-care code component was unintentional or fraudulent. Of course, an audit system may compile indications provided for individual documents from a particular medical-services provider, over time, in order to better estimate the probability that the medical-services provider is submitting fraudulent E/M codes or that the medical-services-provider information system has systematic logic errors that result in producing incorrect E/M codes.

Although the present invention has been described in terms of particular embodiments, it is not intended that the invention be limited to these embodiments. Modifications within the spirit of the invention will be apparent to those skilled in the art. For example, any of many different design and implementation parameters, including programming language, operating system, virtualization technology, hardware platform, modular organization, control structures, data structures, and other such design and implementation parameters can be varied to produce many alternative implementations. The currently described E/M-code-generation methods and systems rely on feature/feature-value pairs computed from medical documents and tables of model weights to compute E/M codes rather than attempting to automate or replicate the complex rule-based manual coding methods currently used for computing E/M codes.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A medical-code generation system comprising:
one or more processors;
one or more memories; and
computer instructions stored in the one or more memories that, when executed by one or more of the one or more processors, control the medical-code generation system to
receive an input document,
store the received document in one or more of the one or more memories,
annotate the input document,
extract concepts from the annotations and the input document,
extract feature values, each extracted feature value based on one or more of the extracted concepts and the annotations,
use the extracted features values to select a medical code to represent the medical document, and
store the medical code in one or more of the one or more memories.

2. The medical-code generation system of claim 1 wherein annotating the input document further includes instantiating multiple annotation objects to represent grammatical, formatting, and semantic features of the contents of the input document.

3. The medical-code generation system of claim 2 wherein each annotation object includes a type and references to the beginning and end of a portion of the input document to which the annotation pertains.

4. The medical-code generation system of claim 2 wherein annotation objects include:
low-level concept objects that represent terms and phrases within the input document identified in one or more dictionaries;
polarity objects that represent various types of polarity terms and phrases that affect the semantic meaning of proximal concepts in the input document;
sentence objects that represent sentences in the input document; and
section-header objects that represent section headers in the input document.

5. The medical-code generation system of claim 1 wherein extracting concepts from the annotations and the input document further comprises:
instantiating concept objects that reference one or more of low-level concept objects, polarity objects, and section objects.

6. The medical-code generation system of claim 1 wherein extracting feature values further comprises:
for each of multiple features, calculating a value based on the concept objects and storing the value in association with a feature name in a feature object.

7. The medical-code generation system of claim 6 wherein features include:
counts of the occurrences of various types of annotation and low-level concept objects within the input document;
counts of the occurrences of various types of annotation and low-level concept objects within a particular section of the input document; and
values calculated from values stored in one or more annotation and low-level concept objects.

8. The medical-code generation system of claim 1 wherein using the extracted features values to select a medical code to represent the medical document further comprises:
for each medical code, computing a score from multiple terms, each term comprising a value obtained from a computational operation on a feature value and a corresponding model weight; and
selecting the medical code associated with a most indicative computed score.

9. The medical-code generation system of claim 8 wherein a most indicative computed score is one of:
a score with largest numerical magnitude;
a score with smallest numerical magnitude; and
a score closest in magnitude to a target score.

10. The medical-code generation system of claim 8 wherein a final medical generated by the medical-code generation system comprises a patient-type/service code combined with a level-of-care code component.

11. The medical-code generation system of claim 10 wherein the medical-code generation system computes a score for each possible patient-type/service code and each possible level that can be assigned to each of multiple key components of a level of care using model weights obtained from sets of model-weight/feature-name entries including a set of model-weight/feature-name entries for each patient-type/service code and for each patient-type/service code/key-component/level combination.

12. The medical-code generation system of claim 10 wherein levels are assigned to each key component based on the computed scores for the patient-type/service code/key-component/level combination and the assigned levels are used to select a level of care.

13. The medical-code generation system of claim 8 wherein the model scores are computed by adjusting an initial set of model weights based on scores computed for a set of input documents with which correct medical codes have been associated using a rule-based medical-code-determination method.

14. The medical-code generation system of claim 1 used as a subsystem within one of:
a third-party medical-code-generation system; and
a medical-services-provider medical-information system.

15. The medical-code generation system of claim 1 used as a subsystem within an insurance system that:
receives an input document and associated medical code;
uses the subsystem to independently compute a medical code from the input document; and
compares the associated medical code with the independently computed medical code to determine a probability that the associated medical code is indicative of billing fraud.

16. A method that generates a medical code that represents an input document, the method carried out in a computer system having one or more processors, one or more memories, and computer instructions stored in the one or more memories that, when executed by one or more of the one or more processors, control the medical-code generation system to carry out the method, the method comprising:
receiving an input document,
storing the received document in one or more of the one or more memories,
annotating the input document,
extracting concepts from the annotations and the input document,
extracting feature values, each extracted feature value based on one or more of the extracted concepts and the annotations,
using the extracted features values to select a medical code to represent the medical document, and
storing the medical code in one or more of the one or more memories.

17. The method of claim 16 wherein annotating the input document further includes instantiating multiple annotation objects to represent grammatical, formatting, and semantic features of the contents of the input document.

18. The method of claim 17 wherein each annotation object includes a type and references to the beginning and end of a portion of the input document to which the annotation pertains.

19. The method of claim 17 wherein annotation objects include:
low-level concept objects that represent terms and phrases within the input document identified in one or more dictionaries;
polarity objects that represent various types of polarity terms and phrases that affect the semantic meaning of proximal concepts in the input document;
sentence objects that represent sentences in the input document; and
section-header objects that represent section headers in the input document.

20. The method of claim 16 wherein extracting concepts from the annotations and the input document further comprises:
instantiating concept objects that reference one or more of low-level concept objects, polarity objects, and section objects.

21. The method of claim 16 wherein extracting feature values further comprises:
for each of multiple features, calculating a value based on the concept objects and storing the value in association with a feature name in a feature object.

22. The method of claim 21 wherein features include:
counts of the occurrences of various types of annotation and low-level concept objects within the input document;
counts of the occurrences of various types of annotation and low-level concept objects within a particular section of the input document; and
values calculated from values stored in one or more annotation and low-level concept objects.

23. The method of claim 16 wherein using the extracted features values to select a medical code to represent the medical document further comprises:
for each medical code, computing a score from multiple terms, each term comprising a value obtained from a computational operation on a feature value and a corresponding model weight; and
selecting the medical code associated with a most indicative computed score.

24. The method of claim 23 wherein a most indicative computed score is one of:
a score with largest numerical magnitude;
a score with smallest numerical magnitude; and
a score closest in magnitude to a target score.

25. The method of claim 23 wherein a final medical generated by the medical-code generation system comprises a patient-type/service code combined with a level-of-care code component.

26. The method of claim 25 wherein the medical-code generation system computes a score for each possible patient-type/service code and each possible level that can be assigned to each of multiple key components of a level of care using model weights obtained from sets of model-weight/feature-name entries including a set of model-weight/feature-name entries for each patient-type/service code and for each patient-type/service code/key-component/level combination.

27. The method of claim 25 wherein levels are assigned to each key component based on the computed scores for the patient-type/service code/key-component/level combination and the assigned levels are used to select a level of care.

28. The method of claim 23 wherein the model scores are computed by adjusting an initial set of model weights based on scores computed for a set of input documents with which correct medical codes have been associated using a rule-based medical-code-determination method.
